(19) United States
(12) Patent Application Publication
(10) Pub. No.: US 2009/0014366 A1
(43) Pub. Date: Jan. 15, 2009

(54) WATER DRINKING DEVICE

(75) Inventors: Hatsumi Takeda, Toyohashi-shi (JP); Atsushi Hatakeyama, Toyohashi-shi (JP); Futomitsu Horiuchi, Tokyo (JP); Hiroki Sakakibara, Ichikawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MRC Home Products Co., Ltd, Chuo-ku (JP)

(21) Appl. No.: 12/278,585

(22) PCT Filed: Feb. 14, 2007
(86) PCT No.: PCT/JP2007/052623

§ 371 Date: Aug. 7, 2008

(30) Foreign Application Priority Data
Feb. 14, 2006 (JP) 2006-037242
Jun. 20, 2006 (JP) 2006-170288
Aug. 2, 2006 (JP) 2006-211095

(51) Int. Cl. B01D 35/14; C02F 1/00; C02F 103/04

(52) U.S. Cl. 210/87; 210/172.1

(57) ABSTRACT

A drinking water device including a water storage section that stores drinking water inside an installation type casing; a water outlet that is connected to the water storage section via a passage and is located outside the casing; filtering device that is provided in the passage on further upstream side of the water outlet so as to be freely attachable/detachable; and a flow rate switch, which is provided between the water storage section and the water outlet and which is capable of detecting flow rate of the drinking water and also capable of outputting an actuating signal upon detecting the flow rate within a preset flow rate range.

### TECHNICAL FIELD

The present invention relates to a drinking water device.

### BACKGROUND ART

An installation type drinking water device has been known to date and this type of drinking water device has been used in households, offices, boardrooms, restrooms, and the like. A tank or a bottle containing a relatively large amount of drinking water is installed in a drinking water device so that the opening thereof is situated below to supply drinking water to the device. For example, as shown in FIG. 32, a drinking water device 50 is configured so that drinking water is supplied from a bottle 53 or the like to a water storage section 52 provided in a casing 51, and the drinking water stored in the water storage section 52 is heated or cooled to a desired temperature using a heating unit 55 or a cooling unit 56, and thereafter the water can be poured into a container such as a cup from a hot water outlet 57 or a cold water outlet 58 (refer to Patent Document 1).

Since such a conventional drinking water device 50 stores drinking water, which does not contain residual chlorine, in the bottle 53 or the water storage section 52, there are hygiene problems such as the high likelihood of microbial proliferation due to the sequential use, and the high likelihood of microbial contamination due to the necessity to incorporate air in the bottle 53 and the water storage section 52 when using the drinking water device 50. The above-mentioned microbial proliferation is likely to occur especially in the passage of such a drinking water device 50 where cold water flows through. Once the microbial proliferation occurs, it will be necessary to clean and sterilize the passage. Moreover, even when a microbe filtering unit is provided in the above-mentioned passage, it is necessary to perform regular maintenance work, such as replacement and washing, on the filtering unit.

In addition, in the above-mentioned drinking water device 50, a cooling water circulation passage is provided inside the device 50, and a sterilizer employing an ultraviolet lamp or a bacteria filtering device employing a hollow fiber membrane is connected thereto. The ultraviolet lamp or the hollow fiber membrane needs to be washed or replaced regularly when the attachment of scales or clogging occurs. However, since the sterilization device or the bacteria filtering device is provided inside the drinking water device and the paths therebetween are intricate, the complicated maintenance work is a problem.

[Patent Document 1] Japanese Unexamined Patent Application, First Publication No. 8-230993

### DISCLOSURE OF INVENTION

### Problems to be Solved by the Invention

An object of the present invention is to provide a drinking water device, which is capable of reliably removing microbes and on which maintenance work can be readily carried out.

### Means for Solving the Problems

In order to solve the above problems, the present invention provides a drinking water device having a water storage section for storing drinking water inside an installation type casing and a water outlet which is connected to the water storage section via a passage and is located externally to the casing, and characterized in that a filtering device is provided in the passage which is situated further upstream side of the water outlet.

With such configurations, microbes can be removed by the filtering device even when the microbial proliferation occurs in the water storage section or the passages of drinking water.

With respect to the passage connecting the filtering device and the water storage section, a return pipe may be connected whose one end is linked to the passage while the other end is open to air.

It is particularly preferable that an angle a formed between the passage and the return pipe in the connecting portion be 90 to 180°.

With such configurations, air removal in the filtering device can be conducted efficiently.

A heating device may also be provided in the passage situated at downstream of the filtering device.

With such a configuration, the passage situated at downstream of the filtering device (the passage situated at the side on which the water outlet is provided) is sterilized by heating.

A filtering device which filters the drinking water may be provided between the water storage section and the water outlet so as to be freely attachable/detachable.

With such a configuration, microbes can be removed by the filtering device even when the microbial proliferation occurs in the water storage section. Hence, it is possible to simplify the water paths inside the casing by omitting the conventional sterilization device or the bacteria filtering device. In addition, since the water paths inside the casing is simplified and also the filtering device is provided so as to be freely attachable/detachable, the operation for replacing the filtering device will become easy.

The casing may have an opening where the filtering device is insertable and the water outlet may be provided in the opening so as to be freely attachable/detachable.

With such configurations, it is possible to attach/detach the filtering device via this opening of the casing by removing the water outlet from the opening.

It is also possible that the filtering device and the water outlet be integrally formed and the filtering device be provided so as to be freely attachable/detachable with respect to the water outlet.

With such a configuration, by attaching/detaching the water outlet that is integrally formed with the filtering device with respect to the drinking water device, the filtering device can also be attached/detached simultaneously.

The filtering device may also be provided so as to be freely attachable/detachable with respect to the water storage section.

With such a configuration, it is possible to attach/detach the filtering device from the water storage section side.

In the water storage section, a cooling device for cooling the drinking water stored in the water storage section may be provided.

With such a configuration, it is possible to simplify the cooling structure and to shorten the passage. Moreover, the microbial contamination or the like can be suppressed due to the cooling of the drinking water stored in the water storage section.

The water paths of the drinking water constituted by the filtering device may be provided so as to be substitutable by a reserve passage.

With such a configuration, it will be possible to carry out the washing of the water storage section as well as all of the water paths via the reserve passage rather than via the filtering device using a cleaning fluid.

Moreover, a flow rate switch capable of detecting the flow rate of the drinking water and also capable of outputting the actuating signal upon detecting the flow rate within a preset flow rate range may be provided between the water storage section and the water outlet.

With such a configuration, it is possible to detect the flow rate of the water flowing through the piping by the flow rate switch.

Furthermore, a pumping device which pumps the drinking water may be provided and driven between the water storage section and the water outlet.

With such a configuration, it is possible to automatically operate a pump depending on the flow rate of the water flowing through the piping.

The pumping device may be controlled to be driven or stopped by the output signal outputted from the flow rate switch.

With such a configuration, it is possible to interlock the drive of the pumping device simultaneously with the change in the flow rate. In addition, the pumping device will not be driven needlessly even when the flow rate is reduced due to the clogging of the filtering device or the like, and as a result, the life expectancy of the pumping device can be prolonged.

The flow rate switch may be a flapper-type flow rate switch.

With such a configuration, it is possible to detect the flow rate of the water flowing through the piping by merely installing the flapper-type flow rate switch.

An indicating unit that indicates an output state of the actuating signal by the lighting of a lamp may be provided on the surface of the casing.

With such a configuration, it is possible to recognize the flow rate of the water flowing through the piping by the operating state of the indicating unit.

The indicating unit may be configured so as to interlock with a lever that is disposed on the water outlet and controls the flow of drinking water from the water outlet, and when the flow rate that is lower than the lower limit value of the preset flow rate range is detected by the flow rate switch, the clogging of the filtering device can be indicated.

With such a configuration, it is possible to indicate when the filtration filter maintenance is needed at a position visible from a user.

The filtering device may be a filter medium or a filtration filter having a hollow fiber membrane and/or an adsorbent.

With such a configuration, it is possible to remove extremely tiny microbes when the filtering device has a hollow fiber membrane, while it is possible to adsorb residual chlorine, mold odor, or the odor imparted inside the drinking water device when the filtering device is provided with an adsorbent.

### EFFECTS OF THE INVENTION

According to the drinking water device of the present invention, the drinking water flowing from the water outlet can be kept clean since microbes are removed due to the provision of the filtering device. In addition, it is possible to remove extremely tiny microbes when the filtering device is formed from a hollow fiber membrane, whereas the filtering device formed from an adsorbent is capable of removing malodor, and thus the drinking water can be kept even cleaner. Moreover, by providing the reserve passage, it is possible to keep the entire path of the drinking water in a clean condition without overloading the filtering device. Due to the filtering device and the reserve passage of the present invention, it is possible to reduce the frequency of the maintenance work, such as cleaning, and to suppress the running cost.

In addition, according to the drinking water device of the present invention, the replacement operation or the maintenance work of the filtering device will become easier by making the filtering device attachable/detachable.

Moreover, according to the drinking water device of the present invention, the maintenance work on the filtration filters can be carried out at an appropriate timing since the flow rate of the water flowing through the piping is detected, controlled, and indicated.

### BRIEF DESCRIPTION OF THE DRAWINGS

FIG. 1 is a front view of a drinking water device according to a first embodiment of the present invention.

FIG. 2 is a partial cross sectional view of a back surface of the drinking water device according to the first embodiment of the present invention.

FIG. 3 is a cross sectional view taken along the line A-A in FIG. 1 according to the first embodiment of the present invention.

FIG. 4 is a cross sectional view taken along the line B-B in FIG. 1 according to the first embodiment of the present invention.

FIG. 5 is a longitudinal sectional view of a filtration filter according to the first embodiment of the present invention.

FIG. 6 is a cross sectional view of a modified example of the first embodiment of the present invention which corresponds to FIG. 3.

FIG. 7 is a cross sectional view of another modified example of the first embodiment of the present invention which corresponds to FIG. 3.

FIG. 8 is a cross sectional view of a second embodiment of the present invention which corresponds to FIG. 3.

FIG. 9 is a longitudinal sectional view of a drinking water device according to a third embodiment of the present invention.

FIG. 10 is a cross sectional view taken along the line A-A in FIG. 9 according to the third embodiment of the present invention.

FIG. 11 is a longitudinal sectional view according to the third embodiment of the present invention which corresponds to FIG. 9 in a state where a filtration cartridge is removed.

FIG. 12 is a partial cross sectional view of FIG. 11 according to the third embodiment of the present invention.

FIG. 13 is a partial cross sectional view according to the third embodiment of the present invention showing a state where a filtration cartridge is installed to a water outlet.

FIG. 14 is a front view of an opening provided in a casing according to the third embodiment of the present invention.

FIG. 15 is a partial enlarged view on the periphery of the filtration cartridge of FIG. 9 according to the third embodiment of the present invention.

FIG. 16 is an enlarged sectional view showing one modified example of the filtration cartridge according to the third embodiment of the present invention which corresponds to FIG. 13.

FIG. 17 is an enlarged sectional view showing another aspect of the filtration cartridge according to the third embodiment of the present invention which corresponds to FIG. 13.

FIG. 18 is an enlarged sectional view showing yet another aspect of the filtration cartridge according to the third embodiment of the present invention which corresponds to FIG. 13.

FIG. 19 is an enlarged sectional view showing a modified example according to the third embodiment of the present invention which corresponds to FIG. 13.

FIG. 20 is an enlarged sectional view showing another modified example according to the third embodiment of the present invention which corresponds to FIG. 13.

FIG. 21 is a schematic diagram showing a modified example according to the third embodiment of the present invention.

FIG. 22 is a longitudinal sectional view according to a fourth embodiment of the present invention which corresponds to FIG. 9.

FIG. 23 is a cross sectional view according to the fourth embodiment of the present invention which corresponds to FIG. 10.

FIG. 24 is a cross sectional view according to the fourth embodiment of the present invention which corresponds to FIG. 22 showing a state where a filtration cartridge of FIG. 22 is removed.

FIG. 25 is a cross sectional view of a filtration cartridge according to the fourth embodiment of the present invention.

FIG. 26 is a cross sectional view showing a modified example of the fourth embodiment of the present invention which corresponds to FIG. 22.

FIG. 27 is a cross sectional view showing the modified example of the fourth embodiment of the present invention which corresponds to FIG. 24.

FIG. 28 is a longitudinal sectional view of a drinking water device according to a fifth embodiment of the present invention.

FIG. 29 is a cross sectional view taken along the line A-A in FIG. 28 according to the fifth embodiment of the present invention.

FIG. 30 is a front view of a drinking water device according to the fifth embodiment of the present invention.

FIG. 31 is a longitudinal sectional view according to the fifth embodiment of the present invention which corresponds to FIG. 28 in a state where a filtration cartridge is removed.

FIG. 32 is a cross sectional view of a conventional drinking water device.

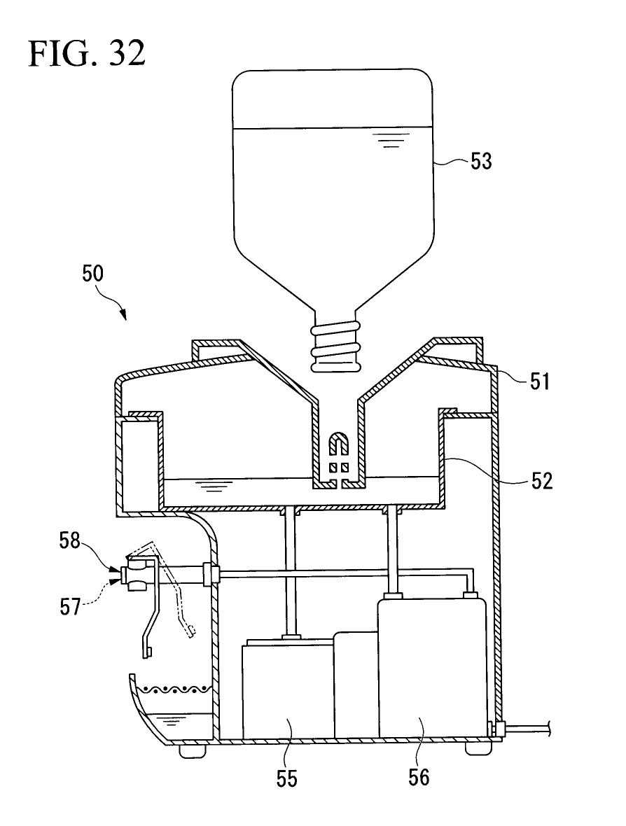

### DESCRIPTION OF THE REFERENCE SYMBOLS

201: Drinking water device
202: Casing
203: Water storage section
218: Water flow pipe for cold water (passage)
128: Water flush pipe for cold water (passage)
129: Return pipe
130: Filtration filter (filtering device)
134: Water outlet
140: Hollow fiber membrane
141: Heater (heating device)
P: Pump (pumping device)
215a: Water outlet
215b: Water outlet
217: Filtration cartridge (filtering device)
241: Opening
208: Cooling unit (cooling device)
230: Hollow fiber membrane
248: Adsorbent
255: Dummy cartridge (reserve passage)
256: Bypass duct (reserve passage)
271: Filtration cartridge (filtering device)
300: Duct (reserve passage)
351: Flapper-type flow rate switch (flow rate switch)
352: Wall surface (casing surface)
353: Indicating unit
P4: Pump

### BEST MODE FOR CARRYING OUT THE INVENTION

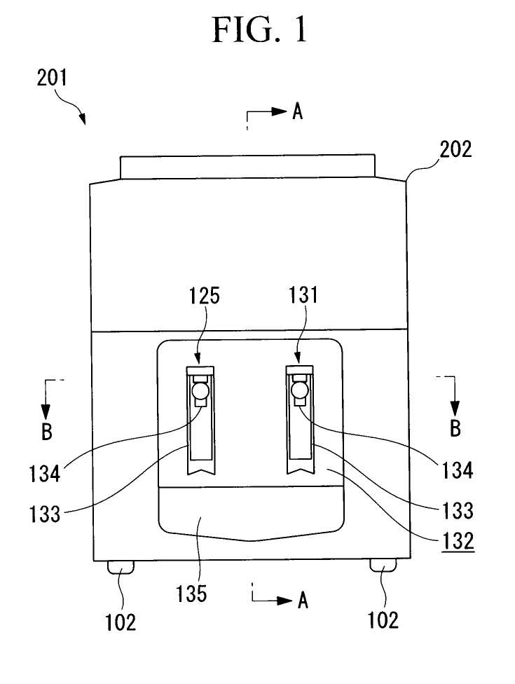

One example of the first embodiment according to the present invention will be described below based on FIGS. 1 to 6.

As shown in FIGS. 1 to 4, a drinking water device 201 has an installation type casing 202 of an almost square shape. The upper part of this casing 202 is mainly configured as a water storage chamber 104 whereas a lower part thereof is mainly configured as a device storage section 105. A cushion 102 made of rubber may be provided on four corners.

A water storage section 203 is provided in the water storage chamber 104 in the upper part of the casing 202. Above this water storage section 203, a bottle insertion slot 205 having a projecting portion 204 where a plurality of supply holes 210 are formed on the side wall thereof is provided, and a base 109 is further provided so that a bottle 206 (with a volume of, for example, about 20 L) for clean water as a drinking water tank can be installed to the drinking water device 201 by placing the opening 207 to face downward. This base 109 is integrally formed from the following components: a cylindrical portion 110 of an almost bottomed cylinder shape which is formed so as to face the water storage section 203 from the opening of an upper wall of the casing 202 of the drinking water device 201; an abutting member 112 formed by expanding upward from the upper edge of the cylindrical portion 110 and abuts and receives the shoulder of the bottle 206; and a support member 113 of a cylindrical shape which is formed by drooping from the upper edge of the abutting member 112 towards the upper wall of the casing 202. The projecting portion 204 is provided in the central part of the bottom of the cylindrical portion 110 and a plurality of supply holes 210 are formed on the side wall thereof.

The bottle 206 is closed by a cap, which is not illustrated. It is configured so that when setting the bottle 206 by making the opening 207 to face downward, removing the cap, and inserting to the projecting portion 204 inside the bottle insertion slot 205, the drinking water in the bottle 206 is poured into the water storage section 203 from the supply holes 210 present on the side wall of the projecting portion 204. It is configured that the opening 207 of the bottle 206, which is purpose built for the drinking water device 201, is usually sealed with a plastic material or a rubber material, and by inserting the projecting portion 204 in the central part of the opening 207, the seal of the opening 207 breaks and the drinking water inside is supplied to the water storage section 203 via the supply holes 210.

An outlet port for hot water P1 and an outlet port for cold water P2 are each formed at the bottom 211 of the water storage section 203. A heating unit 212 is connected to the outlet port for hot water PI via a water flow pipe for hot water 209 whereas a cooling unit 123 is connected to the outlet port for cold water P2 via a water flow pipe for cold water (passage) 218. The heating unit 212 and the cooling unit 123 are disposed in the device storage section 105 below the casing 202 and are fixed to the bottom of the casing 202 via a bracket or the like, which is not illustrated.

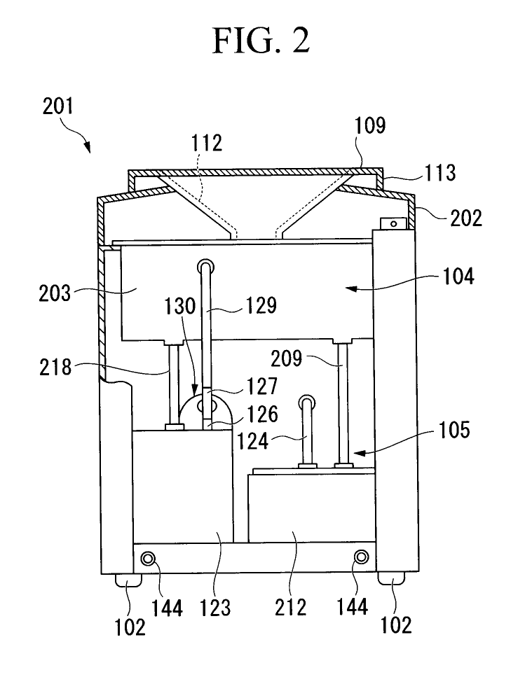

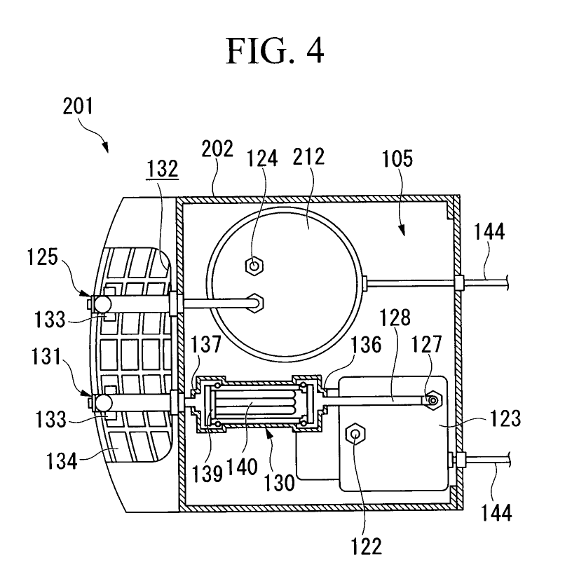

The heating unit 212 heats (for example, up to about 80 to 90° C.) the drinking water supplied from the water storage section 203 via the water flow pipe for hot water 209 using an electrically heated wire or the like. This heating unit 212 is connected to a faucet (tap) for hot water outlet 125 shown in FIGS. 1 and 4 via a water flush pipe for hot water 124 shown in FIG. 2. The drinking water may be heated by incorporating a device such as a Peltier device that efficiently uses the heat released from the refrigeration cycle described later as the heating unit 212.

On the other hand, the cooling unit 123 cools the drinking water supplied from the water storage section 203 via a water flow pipe for cold water 218 using a heat exchanger of the refrigeration cycle. A T connecting pipe (tees) 127 is connected to an outlet port 126 of the cooling unit 123. The outlet port 126 is branched by the connecting pipe 127 and one end thereof is connected to a water outlet 134 of a faucet for cold water outlet 131 via a water flush pipe (passage) for cold water 128 disposed along the horizontal direction whereas the other end is connected to the side wall of the water storage section 203 via a return pipe 129 arranged along an almost the vertical direction, and is opened in a space portion above the liquid level of the water storage section 203. It should be noted that a drain D that discharges the residual water inside the heating unit 212 and the cooling unit 123 to the outside of the casing 202 is connected to the lower back part of the heating unit 212 and the cooling unit 123.

It should be noted that the T connecting pipe (tees) 127 is used in a connecting portion concerning the connection between the water flush pipe (passage) for cold water 128 and the return pipe 129 in the present embodiment. However, in the present invention, instead of such an embodiment, it is also possible to use an integrally formed T tube or a Y tube by connecting the two ends thereof to the outlet port 126 of the cooling unit 123 and the water outlet 134 and opening the one remaining end thereof to air. In this case, within such a T tube (Y tube), the flow path of cold water from the outlet port 126 of the cooling unit 123 to the water outlet 134 is referred to as a “passage”, and the part from the branch point of the T tube (Y tube) to the end thereof which is open to air is referred to as a “return pipe”.

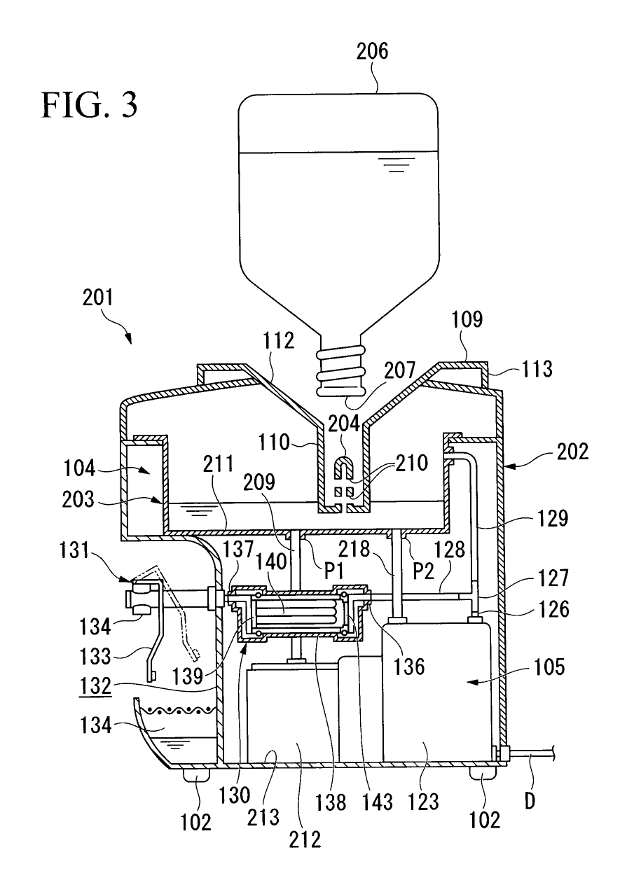

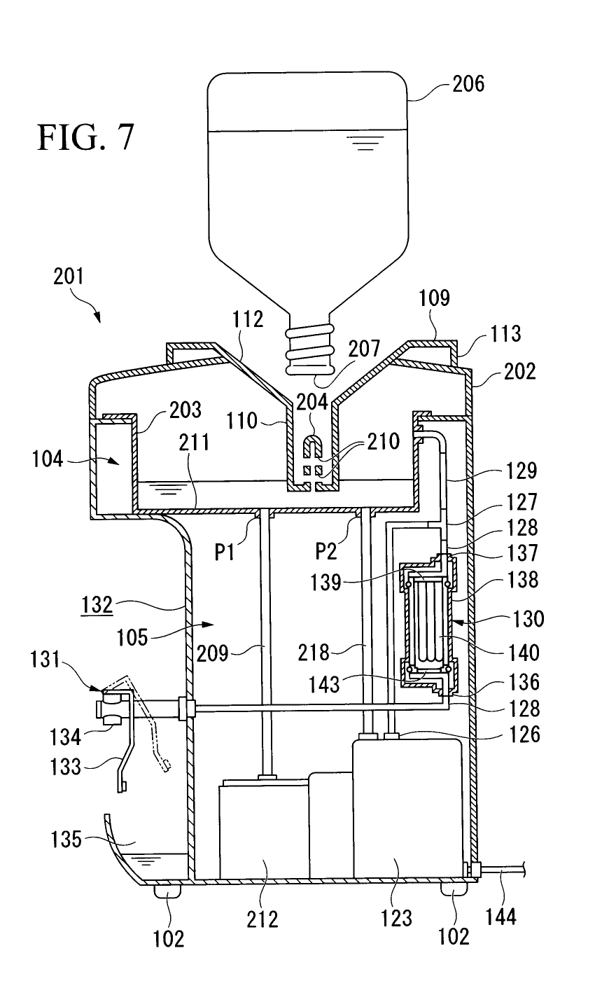

It is preferable that an angle a between the water flush pipe for cold water (passage) 128 and the return pipe 129 be 90 to 180°, more preferably 90 to 120° in order to release the air accumulated inside the filtration filter 130. FIG. 3 shows a case where the angle a between the water flush pipe for cold water (passage) 128 and the return pipe 129 is 90° whereas FIG. 7 shows a case where the angle a between the water flush pipe for cold water (passage) 128 and the return pipe 129 is 180°. As shown in FIG. 7, the angle a between the water flush pipe for cold water (passage) 128 and the return pipe 129 is set to 180° by connecting an intake opening 136 of the filtration filter 130 to the lower end of the T connecting pipe 127 via the water flush pipe for cold water (passage) 128 and connecting the return pipe 129 to the upper end of the connecting pipe 127. In other words, in order to set the angle a between the water flush pipe for cold water (passage) 128 and the return pipe 129 within the above-mentioned range, it is only necessary to adopt a connecting pipe whose branch angle is set within the above-mentioned range, connect the return pipe 129 to the connecting pipe, and, using the connection as a reference, connect the water flush pipe for cold water (passage) 128 to a connection point so that the branch angle will be within the above-mentioned range. It should be noted that a radiator that releases the heat from a refrigerant of the aforementioned cooling unit 123 is usually provided in the back surface of the casing 202 and the refrigerant is cooled by air due to this radiator. However, this radiator is omitted in the figures for convenience of illustration.

As shown in FIGS. 1 and 3, the faucet for hot water outlet 125 and a faucet for cold water outlet 131 are installed to the bottom wall of a concave portion 132 recessed in the front of the casing 202 toward the back thereof. A lever 133 is each provided to the faucet for hot water outlet 125 and the faucet for cold water outlet 131 by being supported at the upper parts of the faucet for hot water outlet 125 and the faucet for cold water outlet 131 and drooping downward. In addition, a water outlet 134 is each provided at the lower parts of the faucet for hot water outlet 125 and the faucet for cold water outlet 131 while facing downward. A recovery container 135 corresponding to this water outlet 134 is formed in the lower part of the casing 202. This recovery container 135 is provided to recover the drinking water spilled from the faucet for hot water outlet 125 and the faucet for cold water outlet 131 and the upper wall thereof is formed in a mesh shape.

It is configured that when a container such as a cup is pressed against the lower part of the lever 133 for example, the faucet for hot water outlet 125 or the faucet for cold water outlet 131 is opened and hot water or cold water flows out from the water outlet 134 and pours into the container, and when the pressing of the container against the lower part of the lever 133 is stopped, the faucet for hot water outlet 125 or the faucet for cold water outlet 131 is closed and the flow of hot water or cold water stops.

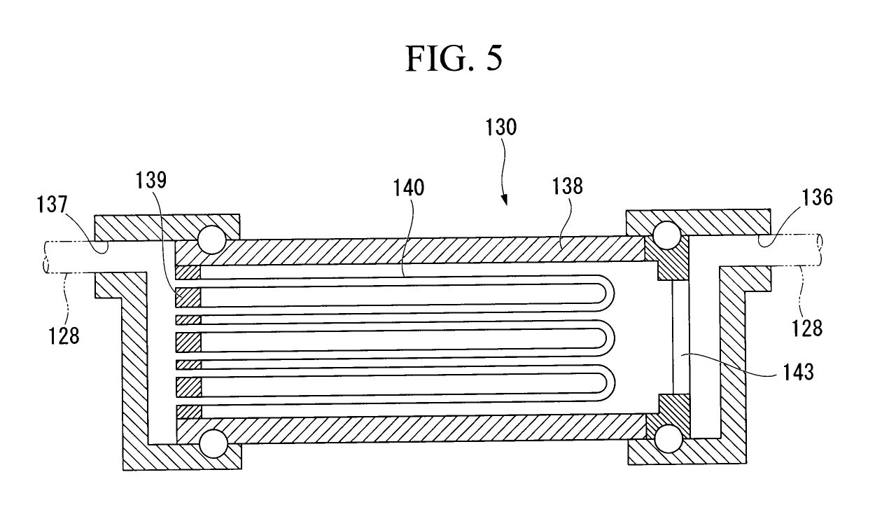

Incidentally, a filtration filter (filtering device) 130 that filters drinking water is provided at a midpoint of the aforementioned water flush pipe for cold water 128. As shown in FIG. 5, this filtration filter 130 has a main case 138 including the intake opening 136 where the water flush pipe for cold water 128 is connected so as to be freely attachable/detachable and a filtered water outlet 137. A filter medium formed of a hollow fiber membrane 140, which is fixed to the main case 138 in a fluid-tight manner by a resin layer 139, is provided inside this main case 138.

In this hollow fiber membrane 140, an intake side and a filtered water side are interrupted by the resin layer 139 made of a potting material such as a urethane resin, an epoxy resin, and a polyolefin resin. Moreover, a prefilter 143 situated further upstream side of the hollow fiber membrane 140 may be provided inside the main case 138. This prefilter 143 is for carrying out crude filtration than that by the hollow fiber membrane 140 before conducting the filtration by the hollow fiber membrane 140. That is, the cold water supplied from the water flush pipe for cold water 128 via the intake opening 136 first passes through the prefilter 143, and then filtered by the hollow fiber membrane 140 and delivered to the water flush pipe for cold water 128, which is connected to the filtered water outlet 137. By providing the prefilter 143, it will be possible to prevent clogging of the hollow fiber membrane 140. As a result, the replacement cycle of filtration filters can be prolonged. Note that the filtering process of drinking water by the hollow fiber membrane 140 is identical to the typical filtering process, and thus a description thereof is omitted.

The hollow fiber membrane 140 is like the one shown as follows.

The hollow fiber membrane 140 is suitably used for filtering out particulate matter of 0.1 μm or larger including microbes and bacteria. Various porous and tubular hollow fiber membranes 140 can be used for this purpose and those formed of various materials such as follows can be used. Examples of the materials include a cellulose based material, a polyolefin (polyethylene and polypropylene) based material, a polyvinyl alcohol based material, an ethylene/vinyl alcohol copolymer based material, a polyether based material, a polymethyl methacrylate (PMMA) based material, a polysulfone based material, a polyacrylonitrile based material, a polyethylene tetrafluoride based material, a polyvinilidene fluoride (PVDF) based material, a polycarbonate based material, a polyester based material, a polyamide based material, and an aromatic polyamide based material. Among them, the hollow fiber membrane 140 of the polyolefin based material such as polyethylene and polypropylene is preferable considering the handleability, workability, and the like of the hollow fiber membrane 140.

In addition, it is preferable that the hollow fiber membrane 140 has an outer diameter of 20 to 2000 μm, a pore size of 0.01 to 1 μm, a porosity of 20 to 90%, and a membrane thickness of 5 to 300 μm. Moreover, concerning the pore size, when measured by the bubble point measurement method (partially modified for measuring hollow fiber membranes) in conformity with ASTM F316-80 or JIS K3832, a value of 100 kPa or more is most preferable.

Additionally, the hollow fiber membrane 140 for filtering raw water is preferably one having a hydrophilic group on the surface thereof, that is, a so-called permanently hydrophilicized hollow fiber membrane. When the surface of the hollow fiber membrane 140 is hydrophobic, passing of the filtered water will be highly difficult with the gravitational hydraulic pressure of the supplied water.

On the other hand, the hollow fiber membrane that takes in air is preferably hydrophobic.

By setting the packing density of the hollow fiber membrane 140 in the main case 138 preferably between 20 to 70%, more preferably between 40 to 65%, and even more preferably between 45 to 60%, the water passing rate in the filtration filter 130 can be enhanced, thereby enabling the purification treatment of a relatively large amount of raw water in a short time.

In addition, as the prefilter 143 provided further upstream side of the hollow fiber membrane 140, a sintered filter formed from a porous sintered powder compact, a nonwoven fabric, a mesh, or the like is suitably used, although it may be any material that conducts crude filtration than that performed by the hollow fiber membrane 140. Among those materials, a polyolefin resin is preferably used since it is light weight when made into a sintered filter, recyclable, does not produce hazardous substances when incinerated, and the pore size thereof is readily controlled.

Additionally, an adsorbent may be provided to the prefilter 143, which is provided further upstream side of the hollow fiber membrane 140. The adsorbent is like the one shown as follows.

Examples of the adsorbents include a powder adsorbent, a particulate adsorbent made by granulating the powder adsorbent, and a fibrous adsorbent. Examples of such adsorbents include the known adsorbents like inorganic adsorbents such as natural product based adsorbents (natural zeolite, silver zeolite, acid clay, and the like), synthetic product based adsorbents (synthetic zeolite, a bacteria-adsorbing polymer, hydroxyapatite, a molecular sieve, silica gel, a silica alumina gel based adsorbent, porous glass, titanium silicate, and the like); and organic adsorbents such as powdered activated carbon, granular activated carbon, fibrous activated carbon, block activated carbon, extrusion-molded activated carbon, shaped activated carbon, a molecule adsorbing resin, synthetic product based granular activated carbon, an ion exchange resin, an ion exchange fiber, a chelate resin, a chelate fiber, a high absorptive resin, a high water-absorptive resin, an oil absorptive resin, and an oil absorbing agent.

Among them, activated carbon which has excellent adsorbability for residual chlorine, mold odor, and organic compounds such as trihalomethane in raw water and ion exchange resins and synthetic product based adsorbents that are excellent in reducing hardness and adsorbing soluble metals are suitably used.

Among activated carbons, granular activated carbon and fibrous activated carbon are suitably used since their contact area with the liquid to be filtered is large and their adsorbability and water passing capability are high.

Examples of activated carbons include plant materials (wood, cellulose, sawdust, charcoal, coconut shell carbon, raw ash, and the like), coal materials (peat, lignite, brown coal, bituminous coal, anthracite, tar, and the like), petroleum materials (petroleum residues, sulfuric acid sludge, oil carbon, and the like), and those derived by carbonizing pulp spent liquor, synthetic resins, or the like, followed by, if necessary, activation (calcium chloride, magnesium chloride, zinc chloride, phosphoric acid, sulfuric acid, caustic soda, KOH, and the like). Examples of fibrous activated carbons include those obtained by carbonizing and activating precursors that are derived from materials such as polyacrylonitrile (PAN), cellulose, phenol, and coal-based pitch.

In terms of the forms of activated carbon, powdered activated carbon, granular activated carbon granulated from this powdered activated carbon, granular activated carbon, fibrous activated carbon, shaped activated carbon obtained by solidifying powdered and/or granular activated carbon by the use of a binder, or the like can be used. Among them, granular activated carbon is suitably used from the viewpoints of a handleability thereof and cost. As the activated carbon, one having a packing density of 0.1 to 0.7 g/ml, an iodine adsorption amount of 800 to 4000 mg/g, and a particle size of 0.075 to 6.3 mm is preferable.

Moreover, it is preferable that the adsorbents include an adsorbent with antimicrobial function since it improves sanitary conditions. Examples of the adsorbents with antimicrobial function include those in which silver is adhered to and/or mixed with the activated carbon.

In addition, it is preferable to use an activated carbon in which the proportion of pores having different pore sizes; i.e., micropore (pore size of 20 E-10 m or less), transitional (pore size of 20 E-10 to 1000 E-10 m), and macropore (pore size of 1000 E-10 to 10000 E-10 m), is adjusted depending on the organic matter to be removed so that the removal capabilities of the activated carbon will be maximized.

For example, when trihalomethane is the object to be removed, it is preferable to use an active carbon with a low proportion of macropores and a high proportion of micropores.

The active carbon may be used alone or in combination with the aforementioned adsorbent. For example, as an adsorbent for removing lead or the like, it is also possible to use titanium silicate, hydroxyapatite, zeolite, a molecular sieve, a chelate resin, or the like which is filled in another layer, mixed to fill up, or impregnated to an active carbon by a binder.

In addition, when water of high hardness is softened, a cation exchange resin is suitably used. Alternatively, it is also possible to use an anion exchange resin for removing nitrate nitrogen, nitrite nitrogen, or the like.

Next, the effects of the above-mentioned drinking water device will be described.

First, when the bottle 206 filled with drinking water is installed to the base for bottle 109 in a manner so that the opening 207 is facing downward, the drinking water inside the bottle 206 is supplied to the water storage section 203. The drinking water supplied to the water storage section 203 is supplied to the heating unit 212 and the cooling unit 123 placed below the water storage section 203 due to its own weight via the outlet port for hot water P1 and the outlet port for cold water P2, respectively. The drinking water supplied to the heating unit 212 will be heated to become hot water and then supplied to the water outlet 134 of the faucet for hot water outlet 125. Hot water flows out from the water outlet 134 due to the opening of the faucet for hot water outlet 125 by pressing the lever 133 of the faucet for hot water outlet 125.

On the other hand, the drinking water supplied to the cooling unit 123 is filtered by the filtration filter 130 for removing microbes and the like, and thereafter supplied to the water outlet 134 of the faucet for cold water outlet 131 due to own weight thereof. Cold water flows out from the water outlet 134 due to the opening of the faucet for cold water outlet 131 by pressing the lever 133 of the faucet for cold water outlet 131. Although it is usually a concern that filtration capability may deteriorate when air accumulates in the main case 138 of the filtration filter 130, the air is released to the space inside the water storage section 203 via the connecting pipe 127 and the return pipe 129 in this embodiment.

Therefore, according to the above-mentioned first embodiment, even when microbes have propagated in the water storage section 203, water flow pipe for cold water 218 or the like, these microbes can be removed by the filtration filter 130, and thus it is possible to reduce the frequency of the maintenance work, such as cleaning, and to suppress the running cost as a result.

In addition, due to the provision of the filter medium formed from the hollow fiber membrane 140 in the filtration filter 130, it is possible to remove extremely tiny microbes, thereby keeping the drinking water clear.

Moreover, since the air accumulated in the filtration filter 130 can be released efficiently due to the provision of the return pipe 129, blockage of water passing due to the presence of air can be prevented. Accordingly, the filtration efficiency of the filtration filter 130 can be enhanced.

It should be noted that although the filtration filter 130 was placed only between the cooling unit 123 and the water outlet 134 of the faucet for cold water outlet 131 in the above-mentioned first embodiment, it is also possible to place the filtration filter 130 between the heating unit 212 and the water outlet 134 of the faucet for hot water outlet 125. Moreover, it is also possible to integrate the faucet for hot water outlet 125 and the faucet for cold water outlet 131 to form a faucet for common outlet and to obtain clean water while switching from hot water to cold water and vice versa using a changeover switch.

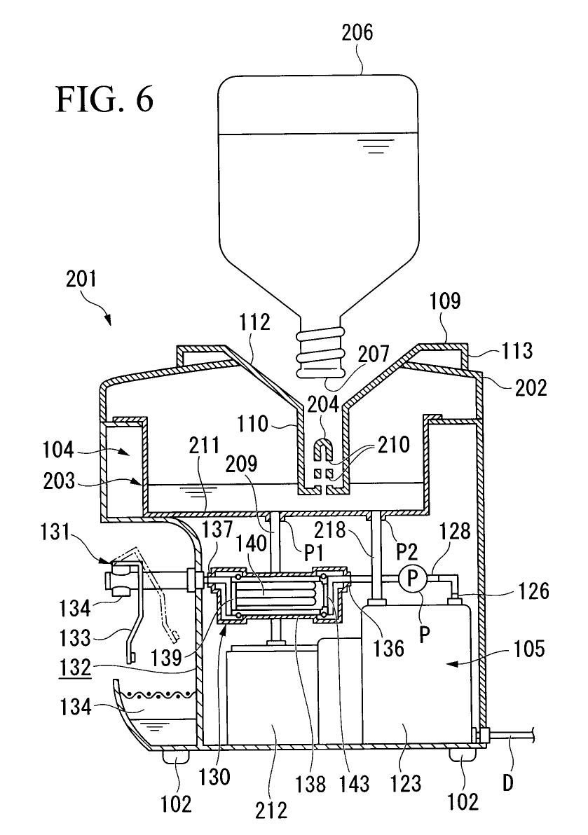

In addition, as shown in FIG. 6, a pump (pumping device) P that pumps the drinking water toward the filtration filter 130 may be provided further upstream side of the filtration filter 130. Note that when such a configuration is adopted, the aforementioned return pipe 129 is not provided since the pump P will suck air in via the return pipe 129. With such configurations, reduction in the flow rate of drinking water due to the filtration filter 130 can be prevented, and thus it is possible to improve merchantability.

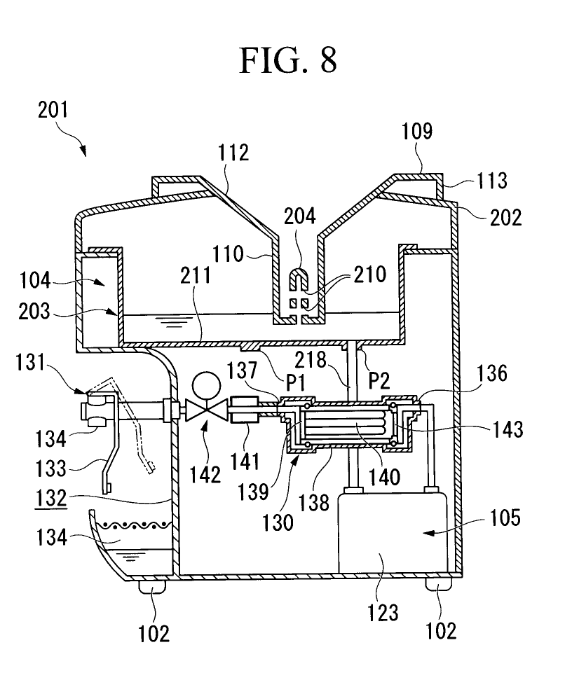

Next, a second embodiment of the present invention is shown in FIG. 8. This second embodiment is one in which a heater and an electromagnetic valve are provided on further downstream side of the filtration filter 130 in the above-mentioned first embodiment. Hence, identical components to those in the first embodiment are given the same reference symbols and the overlapping explanations will be omitted. Note that the return pipe shown in FIG. 3 is omitted in FIG. 6 for convenience of illustration.

As shown in FIG. 8, in the periphery of the water flush pipe for cold water 128 located on further downstream side of the filtration filter 130, a heater (heating device) 141 which heats this water flush pipe for cold water 128 and which is formed from electrically heated wires and the like is installed. An electromagnetic valve 142 is interposed in the water flush pipe for cold water 128, which is positioned further downstream of the heater 141. This electromagnetic valve 142 is configured so as to interlock with the aforementioned lever 133 of the faucet for cold water outlet 131 and, for example, when the lever 133 is pressed (when the water outlet 134 opens), the electromagnetic valve 142 opens, and when the pressing of the lever 133 is terminated (when the water outlet 134 closes), the electromagnetic valve 142 closes after a certain time.

Moreover, the heater 141 is also configured so as to actuate in response to the lever 133 in the same manner as that of the above-mentioned electromagnetic valve 142. For example, it is configured so as to be turned OFF (non-heating state) when the lever 133 is pressed and turned ON (heating state) when the lever is not pressed. Note that the above-mentioned heater 141 may be set so as to be turned OFF after a predetermined amount of time has passed in a state where the lever is not pressed.

Next, a heat sterilization process using the above-mentioned heater 141 and the electromagnetic valve 142 will be described. Note that the premise here is that the equipment is in a normal use state where the drinking water is stored in the water storage section 203, and the cooling unit 123 and the heating unit 212 are in operation.

First, when a container such as a cup is pressed against the lever 133, drinking water flows out from the water outlet 134 and pours into the cup. When the cup is disengaged from the lever 133, the faucet for cold water outlet 131 closes and the flow of drinking water ceases. At this time point, the heater 141 provided in the water flush pipe for cold water 128 turns ON and inside of the water flush pipe for cold water 128, which is positioned further downstream of the filtration filter 130, is heated, and the electromagnetic valve 142 closes after a predetermined time when the sterilization inside this water flush pipe for cold water 128 is completed. Note that in the case where the lever 133 is pressed during the heating of the water flush pipe for cold water 128, it is configured so that the heater 141 stops operating while the electromagnetic valve 142 maintains the open state.

Therefore, according to the second embodiment, at the point in time where the drinking water ceased to flow out from the water outlet 134, the water flush pipe for cold water 128 is heated by the heater 141 and the inside of the water flush pipe for cold water 128 is sterilized, and thereafter the electromagnetic valve 142 is closed to seal the downstream side of the above-mentioned water flush pipe for cold water 128. Accordingly, it is possible to prevent microbes from entering from the water outlet 134 toward the filtration filter 130 side after sterilization. As a result, the downstream side of the filtration filter 130, that is, the water flush pipe for cold water 128 which is closer to the water outlet 134 side than the filtration filter 130 can be kept in a cleaner state, and the microbial contamination of the purified drinking water can be prevented. In this embodiment, although the electromagnetic valve 142 opens, and drinking water flows out from the water outlet 134 when the lever 133 is pressed, the heater is set to be turned OFF in this process and the drinking water cooled by the cooling unit 123 will not be warmed up.

Note that the second embodiment is not limited to the above description and, for example, a pump P shown in FIG. 5 may be provided further upstream of the filtration filter 130. Moreover, although the case where the electromagnetic valve 142 and the heater 141 are provided to the water flush pipe for cold water 128 is explained, the embodiment is not limited to this description and the electromagnetic valve 142 and the heater 141 may be provided to the water flush pipe for hot water 124. Furthermore, it is also possible to integrate the faucet for hot water outlet 125 and the faucet for cold water outlet 131 to form a faucet for common outlet and to obtain drinking water while switching from hot water to cold water and vice versa using a changeover switch.

For example, an electromagnetic valve may be provided on the upstream side of the heater 141. With such configurations, for example, after the lever 133 is returned, the residual water in the water flush pipe for cold water 128 can be sterilized by heating and drying due to the heater 141, and thus it is advantageous since the water can be kept even cleaner. In addition, although explanations were given for the cases where the water outlet 134 opens upon the pressing of the lever 133 in each of the above-mentioned embodiments, it goes without saying that the same also applies to the drinking water device where the water outlet 134 opens when the lever is pulled forward. In this case, ON and OFF of the heater 141 and the electromagnetic valve 142 may be reversed.

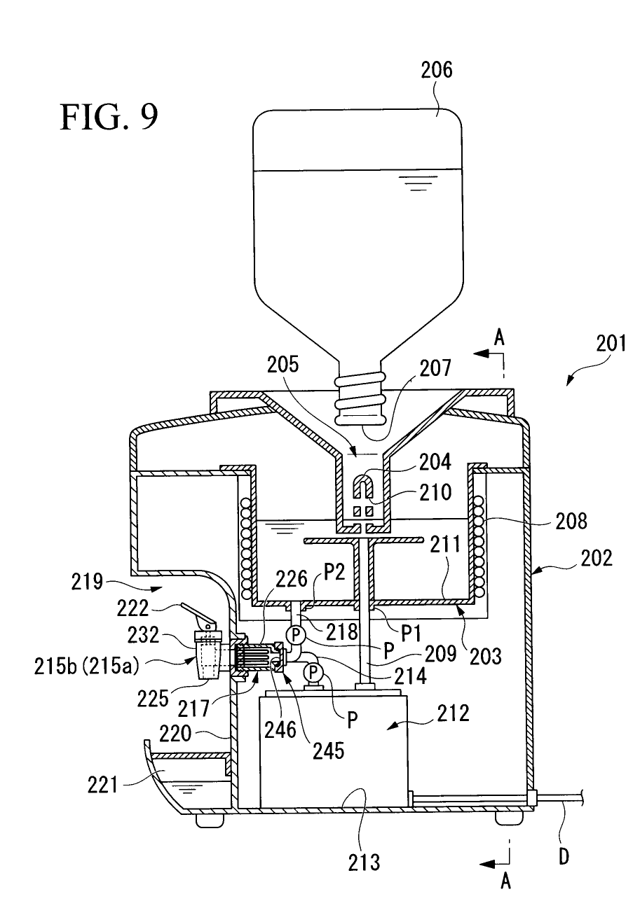

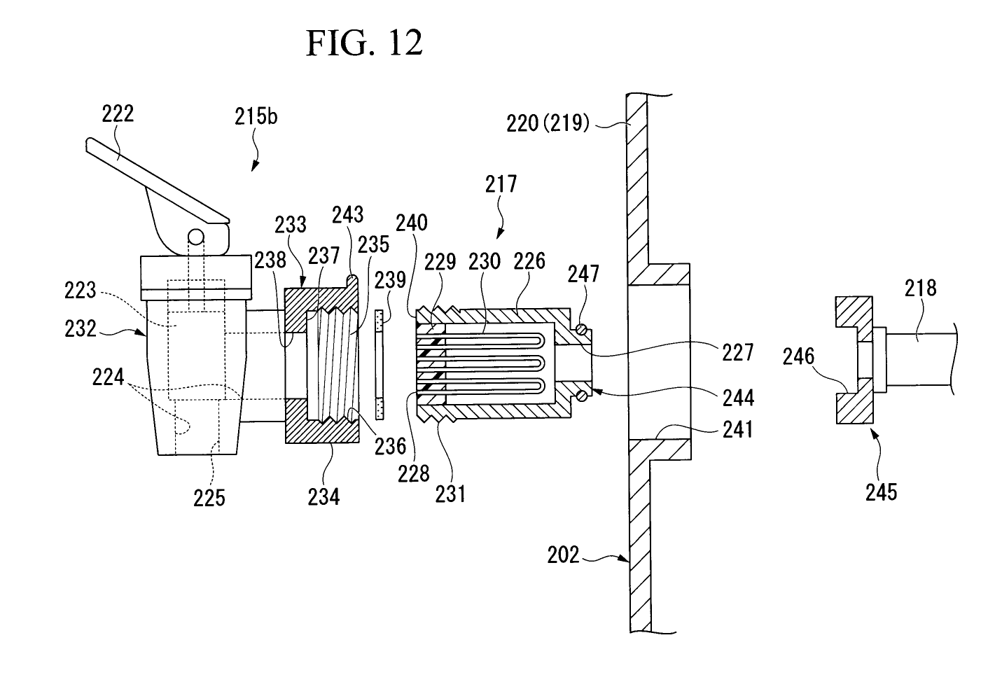

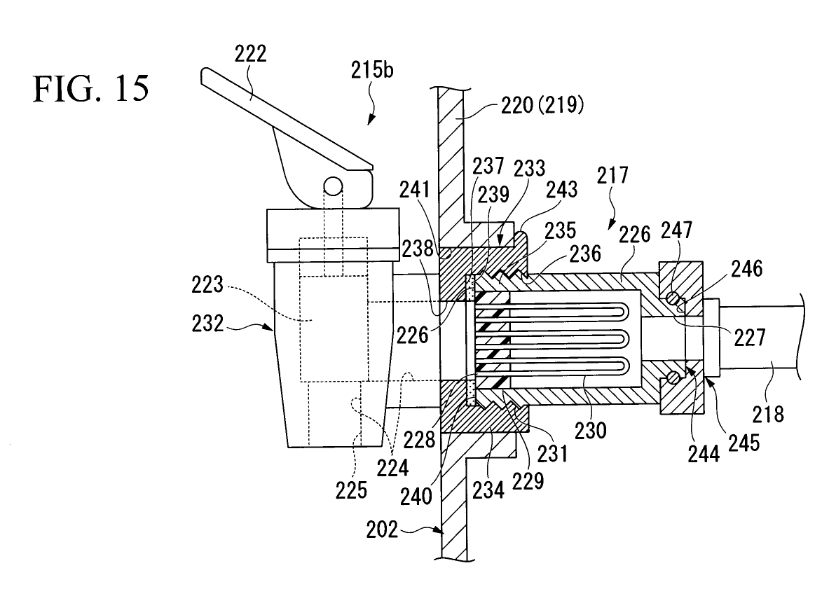

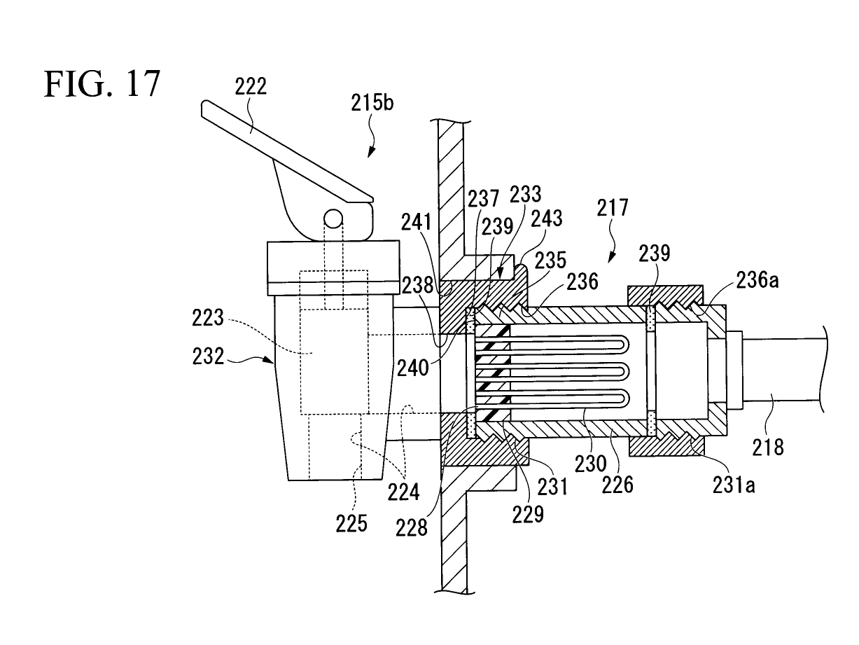

A third embodiment of the present invention will be described based on FIGS. 9 to 21. Note that the descriptions for the reference symbols already explained earlier will be omitted.

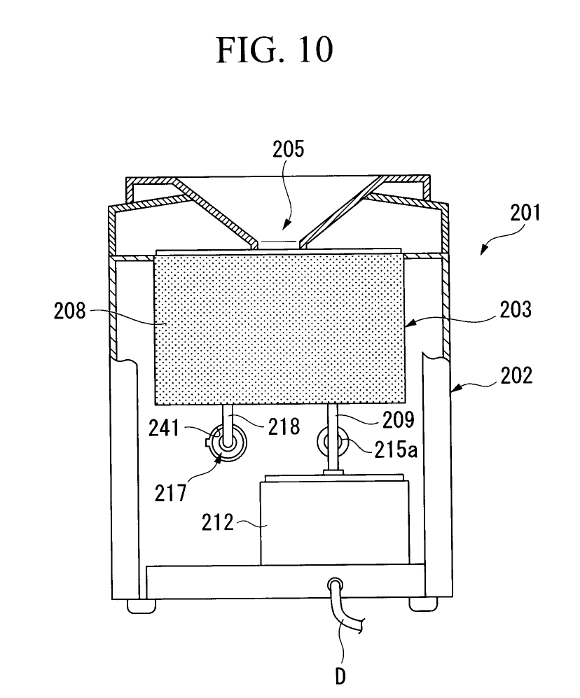

As shown in FIGS. 9 and 10, an outlet port for hot water P1 and an outlet port for cold water P2 are each formed at the bottom 211 of the water storage section 203. A heating unit 212 is connected beyond the outlet port for hot water P1. The heating unit 212 is fixed to the bottom 213 of the casing 202 via a bracket or the like that is not illustrated and it is for heating (for example, up to about 80 to 90° C.) the drinking water supplied from the water storage section 203 via the water flow pipe for hot water 209 using an electrically heated wire or the like. The heating unit 212 is further connected to a water outlet of hot water 215a (refer to FIG. 10) via a water flow pipe for hot water 214. On the other hand, a filtration cartridge (filtering device) 217 is connected beyond the outlet port for cold water P2 and this filtration cartridge 217 is further connected to a water outlet of cold water 215b via a water flow pipe for cold water 218. In the water flow pipe for cold water 218 and the water flow pipe for hot water 214, the pump P for pumping hot water to the water outlet 215a and the pump P for pumping cold water toward the water outlet 215b are interposed, respectively. The drinking water may be heated by incorporating a device such as a Peltier device which efficiently uses the heat released from the refrigeration cycle of the cooling unit 208 as the heating unit 212.

The cooling unit 208 is provided in the outer periphery of the water storage section 203 and cools the water inside the water storage section by a heat exchanger or the like in the refrigeration cycle which constitutes the cooling unit 208. A non-illustrated radiator which constitutes a part of the refrigeration cycle and which releases the heat from a refrigerant of the refrigeration cycle is usually provided in the back surface of the casing 202 and the refrigerant is cooled by air due to this radiator.

In addition, a drain D which discharges the residual water inside the heating unit 212 and the cooling unit 208 to the outside of the casing 2 is connected to the lower part of the heating unit 212 and the cooling unit 208. Note that the drain D of the cooling unit 208 is omitted in FIGS. 9 and 10 for convenience of illustration.

The water outlet of hot water 215a and the water outlet of cold water 215b are installed to the bottom wall 220 of a concave portion 219 recessed in the front of the casing 202 toward the back thereof. A recovery container 221 is formed at the lower part of the casing 202 which corresponds to the water outlets 215a and 215b and it is configured so that the drinking water spilled from the water outlet of hot water 215a and the water outlet of cold water 215b is recovered by this recovery container 221. Note that the upper wall of the recovery container 221 is formed in a mesh shape.

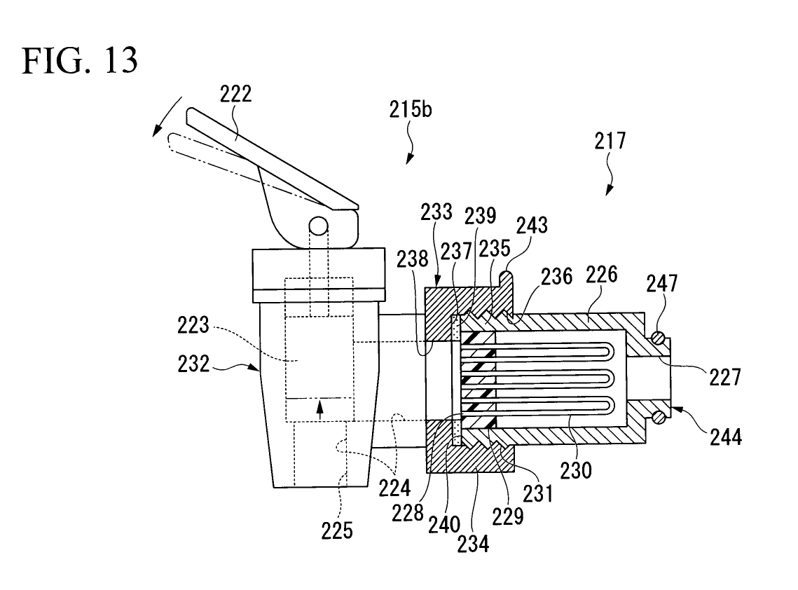

A lever 222 is each provided to the above-mentioned water outlets 215a and 215b which conducts an open/close control of the water outlets 215a and 215b. The open/close control of the water outlets 215a and 215b will be explained by using the case of water outlet 215b as an example. As shown in FIG. 13, for example, when the end of the lever 222 provided in the water outlets 215a and 215b is pressed downward (direction indicated by an arrow in FIG. 13), a faucet 223 linked with the lever 222 rises due to the leverage and a water passage 224 formed inside the water outlets 215a and 215b opens so that hot water and cold water flow out from each opening 225 of the water outlets 215a and 215b, respectively. On the other hand, when the lever 222 is returned upward, a faucet 223 is lowered to block the water passage 224, and thus the flow of hot water or cold water ceases.

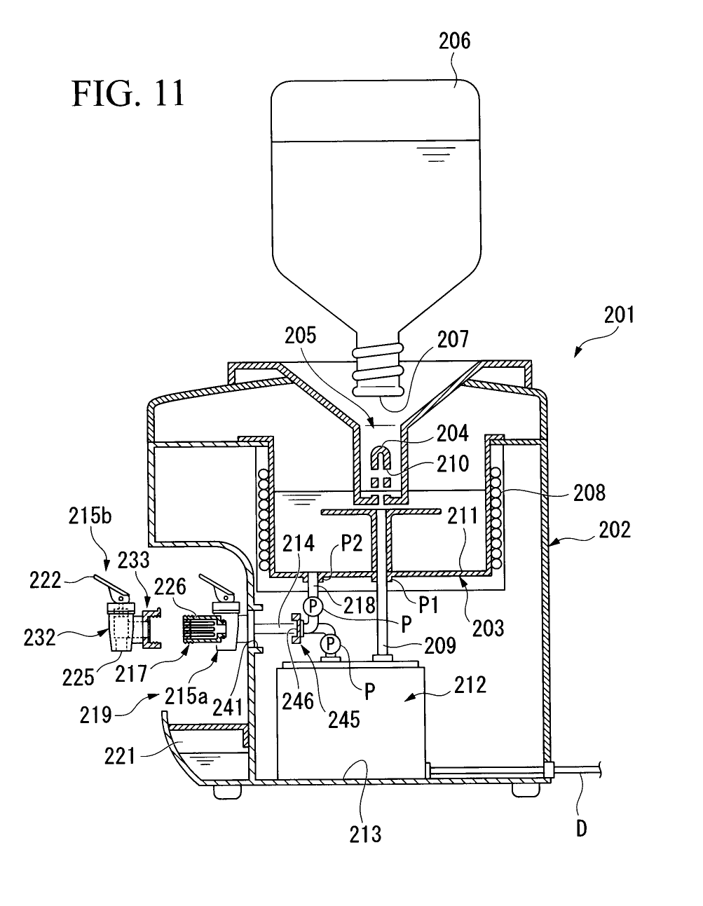

As shown in FIGS. 11 to 13, a filtration cartridge 217 is integrally installed the water outlet 215b via a connecting portion 233 thereof. This filtration cartridge 217 has a main case 226 which has an almost cylindrical shape and this main case 226 has an intake opening 227 on one end thereof and a filtered water outlet 228 on the other. As the filtration cartridge 217, any device such as an ultraviolet sterilizer and an ozone sterilizer can be used as long as it can remove microbes, and it is preferable to use a filtration filter employing a hollow fiber membrane 230. Note that the shape of the main case 226 is not limited to an almost cylindrical shape.

More specifically, a filter medium formed from the hollow fiber membrane 230, which is fixed to the main case 226 on the filtered water outlet 228 side in a fluid-tight manner by a resin layer 229, is installed inside the main case 226 of the filtration cartridge 217. Moreover, the intake opening 227 of the main case 226 is formed so that the peripheral wall thereof has a reduced diameter than the part of the main case 226 on the filtered water outlet 228 side, and an O-ring 247 is mounted in the outer periphery of this reduced diameter portion. On the other hand, a male screw 231 is formed in the outer periphery of the main case 226 on the filtered water outlet 228 side.

On the other hand, the above-mentioned water outlet for cold water 215b is configured from a water outlet body 232 having the lever 222 and the opening 225, and the connecting portion 233 that extends in an almost vertical direction with respect to the water flowing direction of the water outlet 215b. A concave portion 235 is formed on the end 234 of this connecting portion 233. A female screw 236 is formed on the inner peripheral surface of this concave portion 235 and a hole 238 that communicates with the water passage 224 are further formed on the bottom wall 237 of the concave portion 235. As shown in FIG. 13, a ring packing 239 for preventing water leakage is inserted in the concave portion 235, and by inserting the male screw 231 of the filtration cartridge 217 in the female screw 236 of the connecting portion 233 for fastening, the filtration cartridge 217 is fixed to the water outlet 215b. It should be noted that the packing 239 is placed between the bottom wall 237 of the concave portion 235 and the end face 240 of the main case 226 in the filtration cartridge 217 and acts as a seal for these connecting structures.

As shown in FIGS. 11, 12, and 14, an almost circular opening 241, which is larger than the outer diameter of the filtration cartridge 217 and to which the filtration cartridge 217 is insertable, is formed on the bottom wall 220 of the concave portion 219 of the casing 202. In the periphery of this opening 241, a notch 242, which is directed toward radially outward from the right hand side when the periphery of this opening 241 is viewed from the front, is formed. On the other hand, on the outer peripheral surface of the end 234 of the aforementioned connecting portion 233, an engaging projection 243 corresponding to the notch 242 is formed by projecting in the direction opposite to the water flowing direction and radially outward.

It is configured that, when the position of the engaging projection 243 is aligned so as to be in the position of the notch 242, in other words, when the opening 225 of the water outlet 215b is configured to open in the left direction when viewing from the front of the drinking water device 1 and when the connecting portion 233 is inserted in the opening 241, the end 244 of the intake opening 227 in the filtration cartridge 217 installed to the water outlet 215b will hit an outlet side end 245 of the water flow pipe for cold water 218 at a position where the engaging projection 243 of the water outlet 215b is passed through the notch 242, thereby preventing the insertion of the water outlet 215b further inside the casing 202.

On the other hand, a hub 246 that forms a fitting structure together with the intake opening 227 of the filtration cartridge 217 is formed in the outlet side end 245 of the water flow pipe for cold water 218, and it is configured that the intake opening 227 fits into the hub 246 when installing the opening 241 to the water outlet 215b, thereby keeping the fitting structure watertight due to the aforementioned O-ring 247. In this embodiment, the outer diameter of the above-mentioned outlet side end 245 is formed slightly larger than the outer diameter of the filtration cartridge 217. It should be noted that the above-mentioned fitting structure of the filtration cartridge 217 and the water flow pipe for cold water 218 is not limited to the above configuration and, for example, it may be configured so that the hub 246 is formed in the intake opening 227 of the filtration cartridge 217 and the outlet side end 245 of the water flow pipe 218 is inserted and fitted into the hub 246 provided in the intake opening 227.

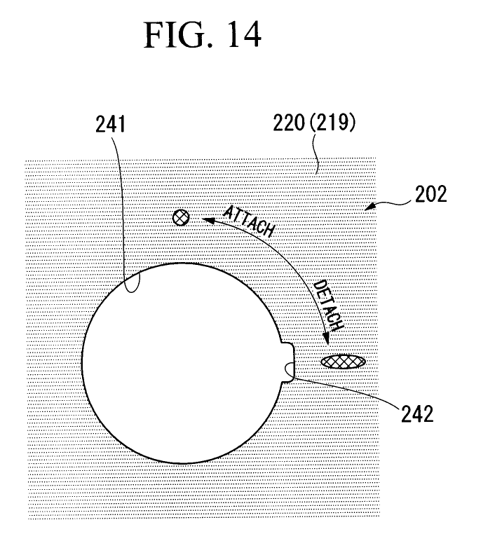

It is configured so that when the water outlet 215b is rotated while in the above conditions in the direction from the state “detach” to the state “attach” shown in FIG. 14, that is, the counterclockwise direction, the engaging projection 243 is locked by the periphery of the opening 241 and the displacement of the water outlet 215b in the insertion/removal direction is regulated. For this reason, the water outlet 215b is fixed to the opening 241 while the opening 225 of the water outlet 215b is facing downward, and the water outlet 215b and the filtration cartridge 217 are installed to the drinking water device 201. When removing the filtration cartridge 217 from the drinking water device 201, the water outlet 215b is rotated in the direction from the state “attach” to the state “detach” shown in FIG. 14 so that the above-mentioned engaged state is terminated. Accordingly, by pulling the water outlet 215b toward the front side of the drinking water device 201, the filtration cartridge 217 that is integrally installed to the water outlet 215b can be removed. Note that a plurality of pairs of the above-mentioned engaging projection 243 and the notch 242 may be provided. Moreover, positions of the notch 242 and the engaging projection 243 may be any positions as long as the opening 225 of the water outlet 215b faces downward when the engaging projection 243 is in an engaged state. It is preferable to provide an indicating sign showing the fitting position or an indicating arrow showing the rotational direction on the water outlet 215b or the casing 202 surrounding the opening 241.

In addition, the rotation angle when installing the water outlet 215b to the opening 241 is preferably 10° or more and less than 90° and more preferably 10° or more and less than 45° for operational ease.

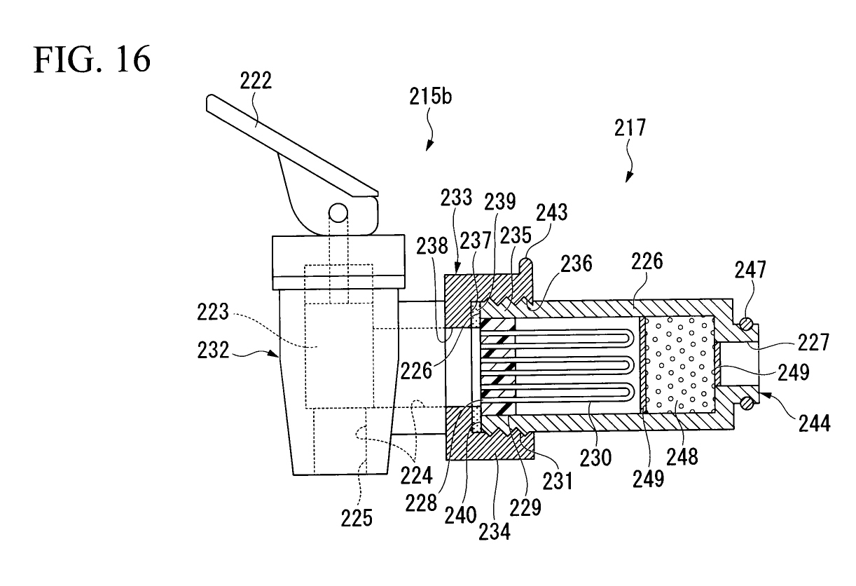

Additionally, as a method for connecting the water outlet 215b, a so-called screw type connection in which a male screw 231a is provided in the water flow pipe for cold water 218 and a female screw 236a is provided in the filtration cartridge 217 as shown in FIG. 16 may be employed. Moreover, various methods such as a bayonet type connection, a spring type connection, and a coupler type connection can be used as long as the method is for fixing.

When the pump P of drinking water is installed to the water flow pipe for cold water 218, which is provided with the filtration cartridge 217, as shown in FIG. 9, high flux can be ensured and at the same time, reduction in the flow rate can be prevented, thereby enabling the improvement of merchantability. As the pump P, any pumps such as magnet pumps, and pressure/vacuum pumps can be used. In addition, it is more preferable to provide an ON/OFF switch of the pump P in the water outlets 215a and 215b and to install them so as to actuate simultaneously with the control of the lever 22.

In the hollow fiber membrane 230 used in the filtration cartridge 217, an intake side and a filtered water side are interrupted by a resin layer made of a potting material such as a urethane resin, an epoxy resin, and a polyolefin resin.

Note that a prefilter may be provided further upstream side of the hollow fiber membrane 230. This prefilter is for carrying out crude filtration than that by the hollow fiber membrane 230 before conducting the filtration by the hollow fiber membrane 230. That is, the cold water supplied from the water flow pipe for cold water 218 first passes through the prefilter and then filtered by the hollow fiber membrane 230 and delivered to the water outlet 215b. By providing the prefilter, it will be possible to prevent clogging of the hollow fiber membrane 230. As a result, the replacement cycle of the filtration cartridge 217 can be prolonged. Note that the filtering process of drinking water by the hollow fiber membrane 230 is identical to the typical filtering process, and thus a description thereof will be omitted. In addition, examples of the hollow fiber membrane 230 are the same as those described earlier.

In addition, as shown in FIG. 16, it is also possible to partition the upstream side inside the main case 26 with a second cut plate 249 and to provide an adsorbent 248 in this partitioned space. Examples of the adsorbent 48 are the same as those described earlier.

It should be noted that when the adsorbent 248 such as activated carbon and an ion exchange resin is provided in the filtration cartridge 217 on the side closer to the intake opening 227 than the hollow fiber membrane 230 as shown in FIG. 16, since it is necessary to form the main case 226 of the filtration cartridge 217 by extending it for the storage space of the adsorbent 248, the position of the outlet side end of the water flow pipe for cold water may be disposed distant from the opening by the same extent as the extension of the main case 226 in this case.

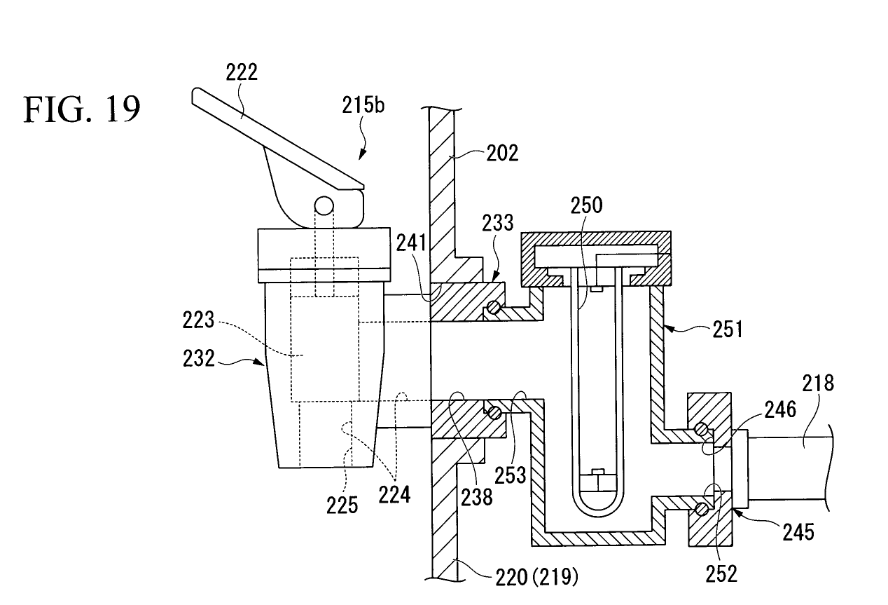

In addition, since the filtration cartridge 217 is provided so as to be freely attachable/detachable as mentioned above, the filtration cartridge 217 can be replaced with a cartridge suitable for the application. For example, as shown in FIG. 19, it is also possible to install a cartridge 251 having an ultraviolet lamp 250 for sterilization. Note that when the intake opening 252 and an unloading opening 253 are offset as in the cartridge 251 shown in FIG. 19, the attaching/detaching operation thereof will be carried out from the inside of the casing 202.

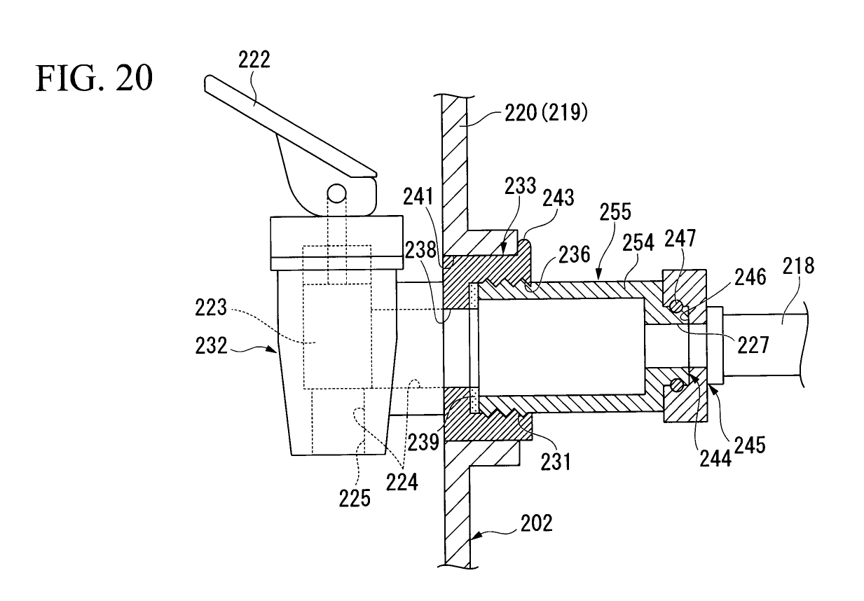

Moreover, when the water paths in the drinking water device 201 is cleaned and sterilized using a cleaning fluid, for example, as shown in FIG. 20, the replacement with a dummy cartridge (reverse passage) 255 having the same main case 254 as that of the aforementioned filtration cartridge 217 while not having the adsorbent 248 or the hollow fiber membrane 230 inside thereof may be adopted. With such configurations, it is possible to constitute a water path where the dummy cartridge 255 replaces the filtration cartridge 217 only when the cleaning, and sterilization using a cleaning fluid is carried out. Accordingly, overloading of the filtration cartridge 217 is avoided, and thus deterioration of the filtration cartridge 217 can be suppressed. Moreover, it is preferable that at least part of the above-mentioned dummy cartridge 255 has a different color from that of the filtration cartridge 217, or be provided with at least one indicating symbol so that it is easy to differentiate the filtration cartridge 217 from the dummy cartridge 255.

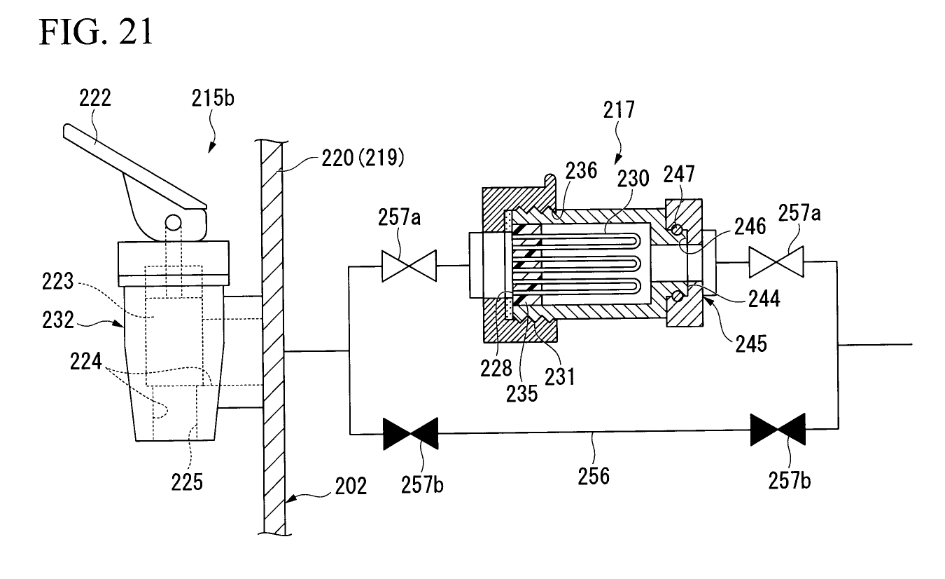

Note that as shown in the schematic diagram of FIG. 21, it is also possible to configure the drinking water device 201 so as to provide a bypass duct (reserve passage) 256 that bypasses the filtration cartridge 217 and valves 257a and 257b that switch the water path to this bypass duct 256, and to bypass the filtration cartridge 217 by the bypass duct 256 due to the control of the valve 257a to a closed state and the valve 257b to an open state only when the cleaning and sterilization using a cleaning fluid is carried out.

Next, the effects of the above-mentioned a drinking water device will be described.

First, when the bottle 206 filled with drinking water is installed to a bottle insertion slot 205 in a manner so that the opening 207 is facing downward, the drinking water inside the bottle 206 is supplied to the water storage section 203, which is provided with the cooling unit 208. The drinking water supplied to the water storage section 203 is supplied to the heating unit 212 via the outlet port for hot water P1 and the drinking water is heated by the heating unit 212 to become hot water and then supplied to the water outlet of hot water 215a. The faucet 223 opens by pressing the lever 222 of the water outlet 215a and the pump P operates due to control of the lever 222, thereby hot water flows out from the water outlet 215a.

On the other hand, the drinking water inside the water storage section 203 is cooled by the cooling unit 208 to become cold water and then supplied from the outlet port for cold water P2. This cold water is supplied to the water outlet for cold water 215b via the filtration cartridge 217. The faucet 223 opens by pressing the lever 222 of the water outlet for cold water 215b and the pump P operates due to the control of this lever 222, thereby cold water from which microbes and the like are removed by the above-mentioned filtration cartridge 217 flows out from the water outlet 215b.

In addition, if the filtration cartridge 217 deteriorates due the repetitive use, since the water outlet 215b and the filtration cartridge 217 can be removed from the drinking water device 201 when the water outlet 215b is rotated to the right direction when viewed from the front and is pulled forward, the filtration cartridge 217 is removed from the water outlet 215b and then replaced or the washing of the water outlet 215b is carried out. When the water outlet 215b and the filtration cartridge 217 are installed to the drinking water device 201, the installation process is conducted by the procedure, which is a reverse of the above-mentioned procedure for removal.

Therefore, according to the above-mentioned third embodiment, since the occurrence of microbial proliferation in the water storage section 203 or drinking water can be prevented due to the filtration cartridge 217, it is possible to omit conventional sterilizers or bacteria filtering devices and to simplify the water paths inside the casing 202. Hence, it is possible to achieve improved maintenance properties. In addition, since the water paths inside the casing 202 are simplified and also the filtration cartridge 217 is provided so as to be freely attachable/detachable, the operation for replacing the filtration cartridge 217 will become easy.

Moreover, since the filtration cartridge 217 is attachable/detachable via the opening 241 by removing the water outlet of cold water 215b from the opening 241 of the casing 202, the filtration cartridge 217 can be replaced without removing the components inside the casing 202 such as the water storage section 203. As a result, it is possible to achieve further improved maintenance properties.

Furthermore, when the water outlet 215b to which the filtration cartridge 217 is installed is attached to/detached from the casing 202, the filtration cartridge 217 can be attached to/detached from the drinking water device 201 simultaneously, thereby the attachment/detachment of the filtration cartridge 217 can be readily carried out.

When the hollow fiber membrane 30 is provided, extremely tiny microbes can be removed. On the other hand, when the adsorbent 248 is provided, it is possible to adsorb residual chlorine, mold odor, or the odor imparted inside the drinking water device. Accordingly, the drinking water that flows out from the water outlet 215b can be kept cleaner.

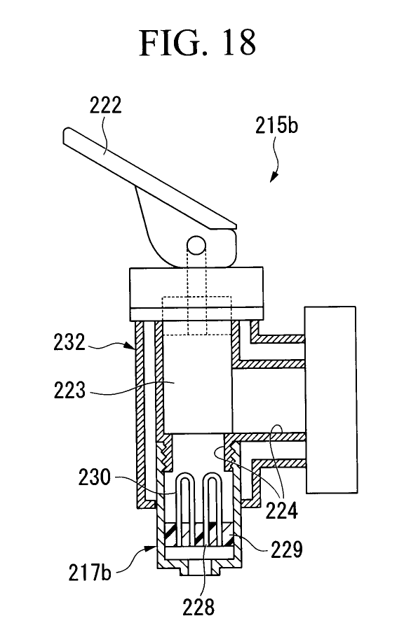

Note that the third embodiment is not limited to the above description and, for example, as shown in FIG. 18, a filtration cartridge 217b may be provided in an opening of the water outlet 215b so as to be freely attachable/detachable. Such a configuration is advantageous since the operation for replacing the filtration cartridge 217b can be carried out without removing the water outlet 215b from the drinking water device 1.

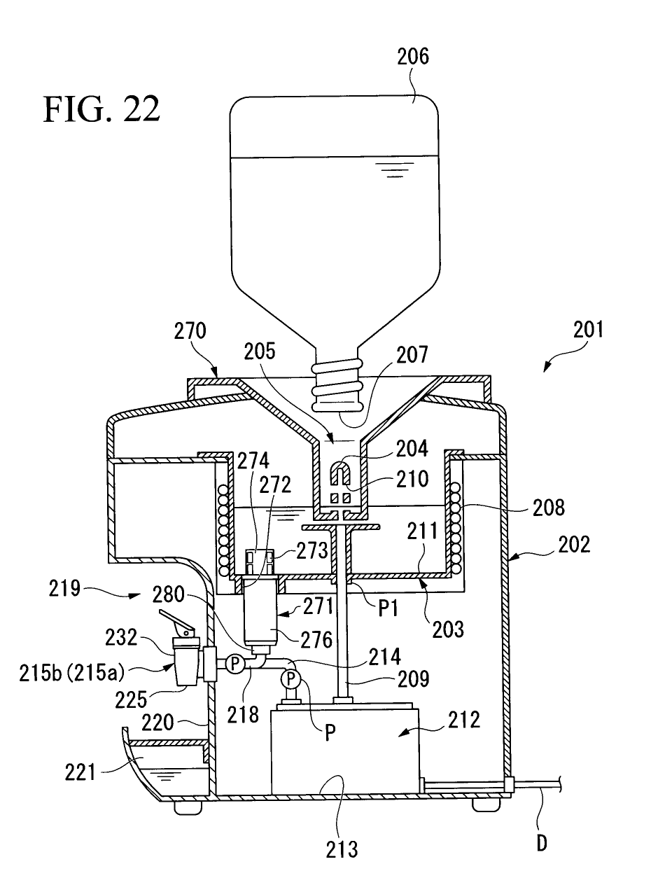

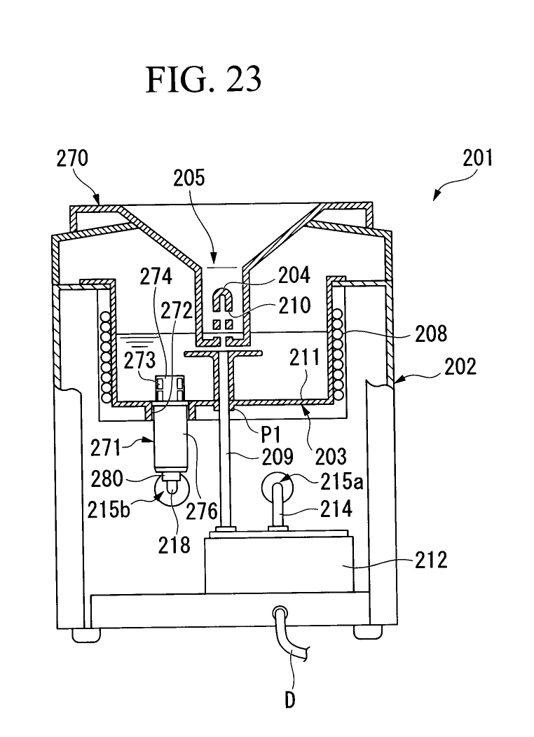

A drinking water device according to a fourth embodiment of the present invention will be described based on FIGS. 22 to 26.

Note that since this fourth embodiment is different from the above-mentioned third embodiment only in the location where the filtration cartridge is installed, identical components are given the same reference symbols and the overlapping explanations will be omitted.

As shown in FIGS. 22 to 24, the drinking water device 201 has a casing 202 and a lid 270 is provided in the upper part of this casing 202 so as to be attachable/detachable. In this lid 270, the bottle insertion slot 205 having the projecting portion 204 where a plurality of supply holes 210 are formed on the side wall thereof is provided so that the bottle 206 for clean water can be installed to the drinking water device 201 by placing the opening 207 to face downward. The water storage section 203 in which the cooling unit 208 is provided in the outer periphery thereof is disposed below this bottle insertion slot 205.

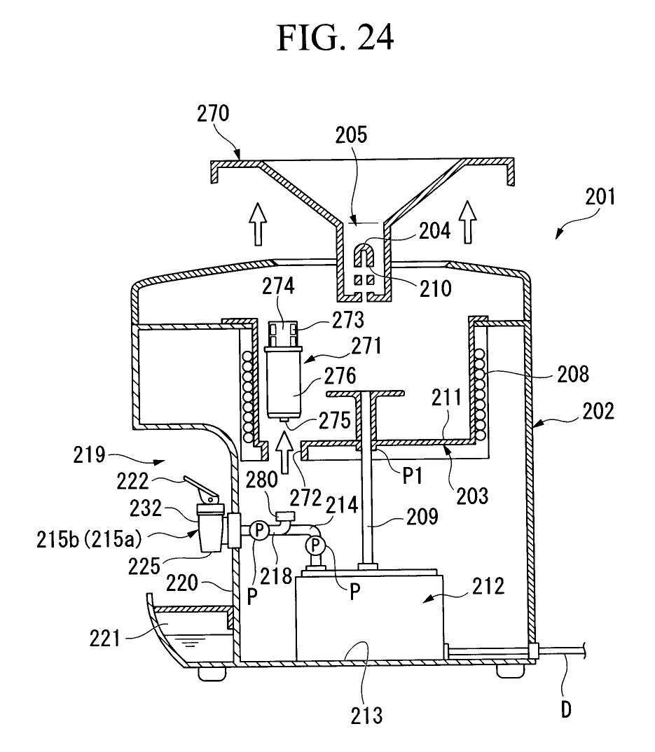

Although the lid 270 may be placed on any positions out of the upper surface, the side surface, the back surface, and the front surface of the drinking water device 201 as long as it can be disposed at a position capable of facing inside the water storage section 203, it is preferable to be arranged on the front surface or the upper surface since the attaching/detaching operation of the lid 270 can be conducted without moving the drinking water device 201 even when the drinking water device is installed against a wall. In addition, as shown in FIG. 24, it is preferable since the washing of the bottle insertion slot 205 can be readily carried out by integrally forming the lid 270 with the bottle insertion slot 205 having the projecting portion 204.

The outlet port for hot water P1 is formed at the bottom 211 of the water storage section 203 as in the above-mentioned third embodiment. On the other hand, an installation opening 272 is formed at the bottom 211 instead of the outlet port for cold water P2 present in the above-mentioned third embodiment and the filtration cartridge (filtering device) 271 is configured so as to be freely attachable to/detachable from this opening.

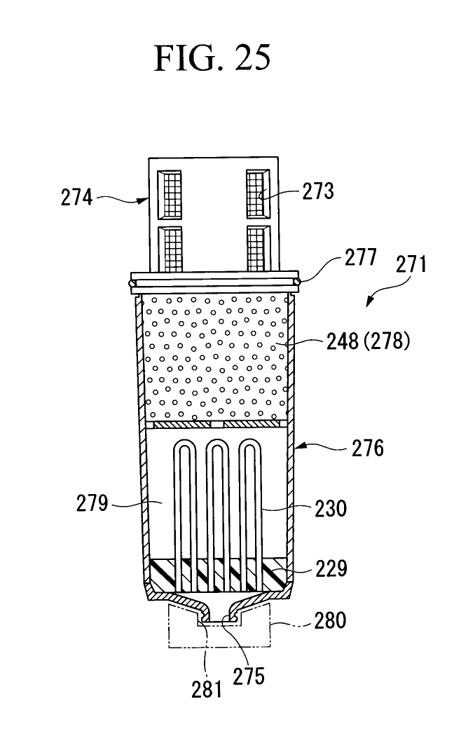

As shown in FIG. 25, the filtration cartridge 271 includes a tubular cap 274 having an intake opening 273 that takes in raw water in the outer periphery and a main case 276 that is integrally formed with this cap 274 and having a filtered water outlet 275 at its lower end. An O-ring 277 is mounted in the outer periphery of the upper part of the main case 276 and this O-ring 277 acts as a seal between the water storage section 203 and the main case 276 while the filtration cartridge 271 is installed. A first purification section 278 formed from an adsorbent 248 such as granular activated carbon is provided on the upstream side inside the main case 276 and a second purification section 279 having the hollow fiber membrane 230, which is fixed to the main case 276 in a fluid-tight manner by the resin layer 229, is provided on the downstream side inside the main case 276. Since the adsorbent 248, the hollow fiber membrane 230, and the resin layer 229 are the same as those in the third embodiment, their detailed descriptions will be omitted.

The filtered water outlet 275 of the filtration cartridge 271 is configured so as to fit into a concave portion 281 (refer to FIG. 25) of a hub 280 provided in the water flow pipe for cold water 218 while the filtration cartridge 271 is installed to the water storage section 203. A non-illustrated seal such as an O-ring is provided in this hub 280 so as to keep watertightness. In addition, the pump P is provided at a midpoint of the water flow pipe for cold water 218 so as to pump drinking water to the water outlet 215b installed to the casing 202. Note that the pump P may be provided where necessary, and thus may be omitted.

Next, the effects of the above-mentioned fourth embodiment will be described. Note that since the function of the drinking water device 201 itself is the same as that in the aforementioned third embodiment, only the description on the replacement operation of the filtration cartridge 271 will be provided.

First, the bottle 206 that is inserted in the bottle insertion slot 205 is removed from the drinking water device 201. As shown in FIG. 24, when the lid 270 mounted on the bottle 6 is lifted upward, the water storage section 203 can be seen from the upper opened portion of the casing 202. When the cap 274 of the filtration cartridge 271 is gripped and lifted upward, the filtration cartridge 271 is removed from the installation opening 272 of the water storage section 203. This removed filtration cartridge 271 is replaced by a new one and the filtration cartridge 271 is once again inserted in the installation opening 272 and pressed until the filtered water outlet 275 fits into the concave portion 281 of the hub 280. Finally, the upper opened portion of the casing 202 is blocked by the lid 270 to complete the operation for inserting the bottle 206 in the bottle insertion slot 205.

Therefore, according to the above-mentioned fourth embodiment, since the filtration cartridge 271 may be attached/detached with respect to the installation opening 272 formed at the bottom 211 of the water storage section 203 by removing the lid 270, the filtration cartridge 271 can be readily attached/detached without removing components such as the water storage section 203.

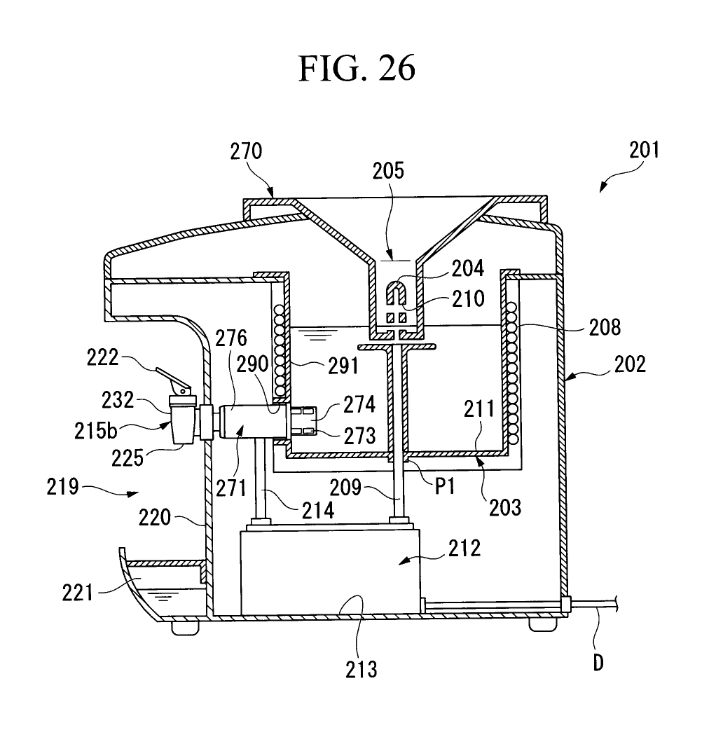

It should be noted that as another aspect of the above-mentioned fourth embodiment, for example, as shown in FIG. 26, a configuration is also possible where an installation opening 290 is provided in a side wall 291 of the water storage section 203, the water outlet 215b is provided in the casing 2 at the position opposite to the installation opening 290, and the water storage section 203 and the water outlet 215b are connected only via the filtration cartridge 271. With such a configuration, the water flow pipe for cold water 218 can be omitted. Accordingly, the number of components can be reduced and further simplification of water paths can be achieved. In addition, the maintenance work conducted on the water flow pipe for cold water 218 using drugs can be omitted, and thus it is advantageous since the maintenance work can be alleviated.

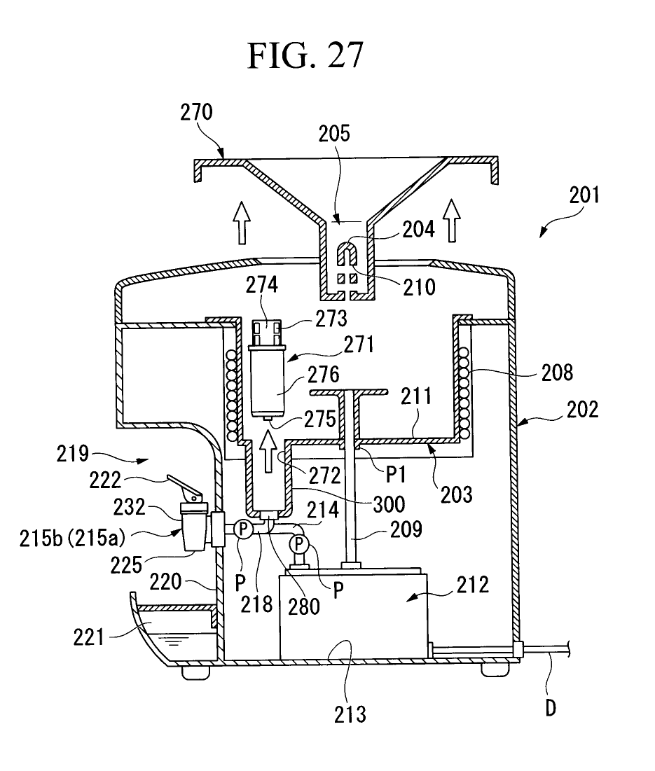

Moreover, for example, when the water paths in the drinking water device 201 are cleaned and sterilized using a cleaning fluid, as is the same with the aforementioned third embodiment, it is also possible to configure the drinking water device 201 so that the filtration cartridge 271 is replaceable with a dummy cartridge (not illustrated) or to provide a bypass duct (not illustrated) and a valve (not illustrated) separately. Furthermore, as shown in FIG. 27, it is also possible to provide a duct 300 (reserve passage) that is connected from the above-mentioned installation opening 272 to the outer periphery of the hub 280 and also covers the outside of the filtration cartridge 271. With such a configuration, when the filtration cartridge 271 is removed, a water path that connects the water storage section 203 and the water flow pipe for cold water 218 will be constituted by the duct 300. In particular, by providing the duct 300 as described, the valve control for replacing the filtration cartridge 271 with the dummy cartridge or for switching to the bypass conduct is no longer required. Accordingly, it is advantageous since the number of steps required for the maintenance work can be reduced, thereby alleviating the load on maintenance operators.

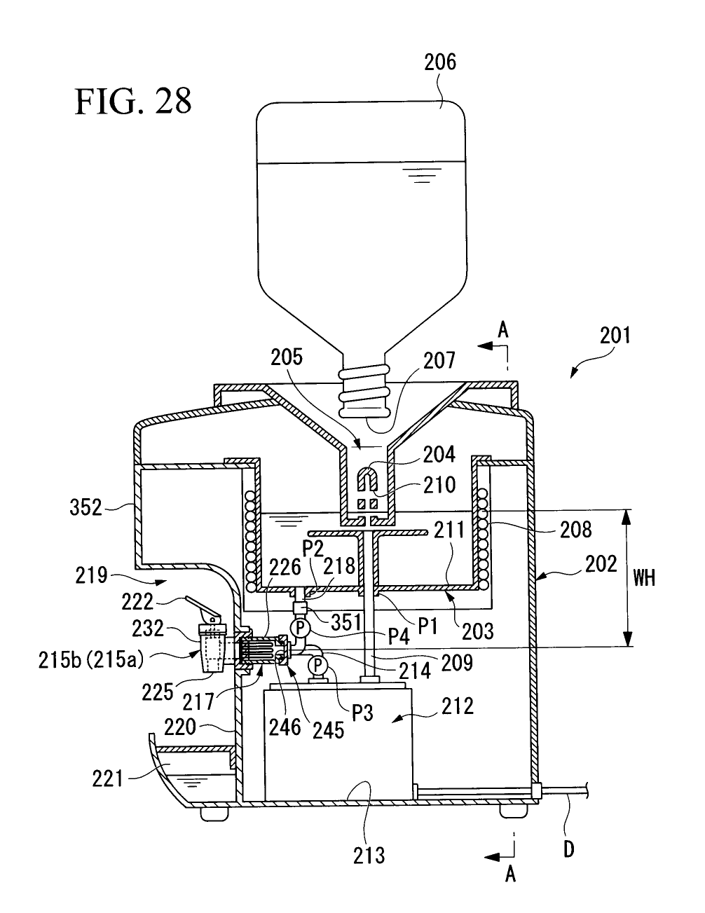

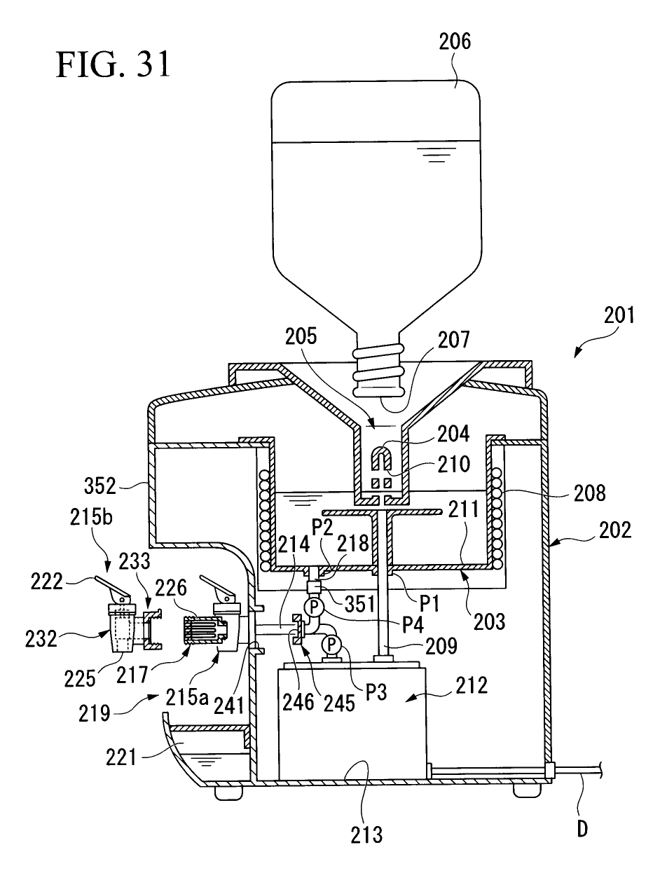

Next, a fifth embodiment of the present invention will be described based on FIGS. 28 to 31. Note that the descriptions for the reference symbols already explained earlier will be omitted.

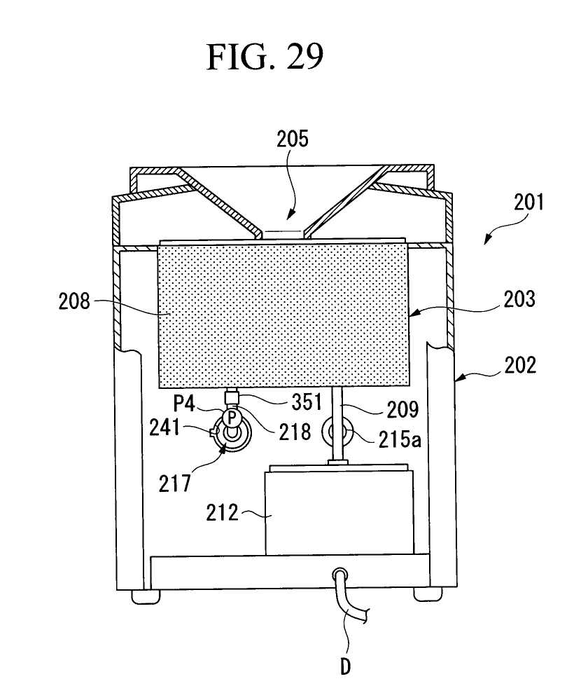

As shown in FIGS. 28 and 29, a pump P3 that pumps hot water to the water outlet 215a is provided in the water flow pipe for hot water 214 and a pump P4 that pumps cold water to the water outlet 215b is provided in the water flow pipe for cold water 218. In addition, a flapper-type flow rate switch 351 is disposed between the outlet port for cold water P2 and the pump 4.

The flapper-type flow rate switch 351 is configured so that actuating signals are outputted when the amount of water flow is within a preset flow rate range, which is 0.3 to 3.5 liter per minute (LPM). Specifically, a passage is formed inside the flapper-type flow rate switch 351, a flapper is provided in the passage so as to be rotatable, and a magnet and a reed switch are provided in the flow rate switch body. When water is not flowing, the magnet installed in the flapper and the magnet of the flow rate switch body are attracting each other. It is configured so that the flapper is pushed up when water flows, and when the water flow rate reaches the preset flow rate, the reed switch is turned ON by the magnet of the flapper and output the actuating signals. In addition, it is configured so that the flapper is lowered when the flow rate is reduced due to the self weight of the flapper and the magnetic force of the magnet in the flow rate switch body, and the reed switch is turned OFF when the water flow rate falls below the preset flow rate.

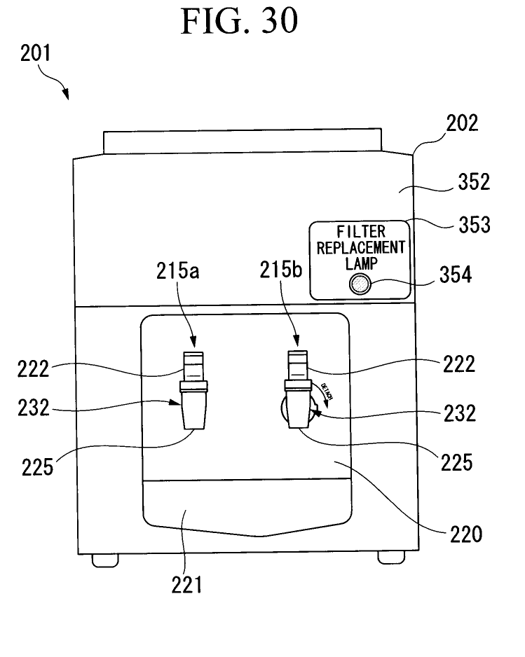

As shown in FIG. 30, an indicating unit 353 that indicates when the maintenance of filtration cartridge 217 is needed is provided on a wall surface 352 in the front surface of the casing 202. A lamp 354 formed of LED or the like is provided in the indicating unit 353. In the present embodiment, the flapper-type flow rate switch 351 and the lamp 354 are electrically connected by a non-illustrated electric wire or the like so that the lamp 354 in the indicating unit 353 lights up when the actuating signals of the flapper-type flow rate switch are outputted.

When the pump P4 of drinking water is installed to the water flow pipe for cold water 218, which is provided with the filtration cartridge 217, as shown in FIG. 28, stable flow rate can be ensured, thereby enabling the improvement of merchantability. As the pump P4, any pumps such as magnet pumps, and pressure/vacuum pumps can be used. In addition, it is configured so that the ON/OFF of the pump P4 operation is interlocked with the output signal of the flapper-type flow rate switch 351. That is, it is configured so that the pump P4 starts operating if the water flow rate in the piping is within the range of 0.3 to 3.5 LPM when the lever 222 is pressed downward and drinking water flows out due to its own weight.

Next, the effects of the drinking water device 201 will be described.

First, when the bottle 206 filled with drinking water is installed to a bottle insertion slot 205 in a manner so that the opening 207 is facing downward, the drinking water inside the bottle 206 is supplied to the water storage section 203, which is provided with the cooling unit 208. In this case, differences of about 250 mm in the water head (height difference) WH between the water surface of the drinking water stored in the water storage section 203 and the intake opening 227 are ensured. Although it is arranged so that the differences in the water head WH is 250 mm in this case, the differences in the water head WH are preferably 150 to 300 mm, more preferably 200 to 250 mm since satisfactory structure balance can be achieved when the differences are set within the above range.

The drinking water supplied to the water storage section 203 is supplied to the heating unit 212 via the outlet port for hot water P1 and the drinking water is heated by this heating unit 212 to become hot water and then supplied to the water outlet of hot water 215a. The faucet 223 opens by pressing the lever 222 of the water outlet 215a and the pump P3 operates due to the control of this lever 222, thereby hot water flows out from the water outlet 215a.

On the other hand, the drinking water inside the water storage section 203 is cooled by the cooling unit 208 to become cold water and then supplied from the outlet port for cold water P2. This cold water is supplied to the water outlet for cold water 215b via the filtration cartridge 217.

Specifically, the faucet 223 opens by pressing the lever 222 of the water outlet for cold water 215b and cold water flows out from the water outlet 215b due to its own weight. Next, the water flow rate when cold water passes through the water flow pipe for cold water 218 is determined by the flapper-type flow rate switch 351, and the actuating signals are outputted when the flow rate within the preset range is detected. By the output of the actuating signals, the pump P4 operates and cold water flows out from the water outlet 215b at a flow rate of about 2.5 LPM. During the process, the cold water from which microbes and the like are removed by the filtration cartridge 217 flows out from the water outlet 215b.

If the filtration cartridge 217 with the hollow fiber membrane having a membrane area of about 0.7 m2 is adopted in this case, cold water flows out from the water outlet 215b due to the self weight of drinking water at a flow rate of about 0.5 LPM when the filtration cartridge 217 is not clogged.

In addition, the indicating unit 353 indicates whether the actuating signals of the flapper-type flow rate switch 351 are outputted or not. When the lamp 354 of the indicating unit 353 does not light up even when the lever 222 is pressed, the flow rate of cold water due to its own weight is less than 0.3 LPM. This can be judged that the flow rate is reduced since the hollow fiber membrane 230 in the filtration cartridge 217 is clogged.

That is, when the filtration cartridge 217 is not clogged, the lamp 354 is unlit while the drinking water device is not used and lights up when the lever 222 is pressed. On the other hand, when the filtration cartridge 217 is clogged, the lamp 354 remains unlit even if the lever 222 of the drinking water device 201 is pressed.

When the user using the drinking water device 201 observes the unlit state of the lamp 354 as described above, he should judge that it is time for the maintenance work of the filtration cartridge 217 and carry out washing or replacement of the filtration cartridge 217.

When carrying out the maintenance work on the filtration cartridge 217, since the water outlet 215b and the filtration cartridge 217 can be removed from the drinking water device 201 by rotating the water outlet 215b to the right direction when viewed from the front and pulling forward, the filtration cartridge 217 is removed from the water outlet 215b and then replaced or the washing of the water outlet 215b is carried out. When the water outlet 215b and the filtration cartridge 217 are installed to the drinking water device 201, the installation is conducted by the procedure, which is reverse to the above-mentioned procedure for removal.

Therefore, according to the above-mentioned embodiment, the filtration cartridge 217 that filters drinking water, the pump P4 that pumps drinking water, and the flapper-type flow rate switch 351 that detects the flow rate of drinking water are provided between the water storage section 203 and the water outlet 215b in the drinking water device 201. With such a configuration, it is possible to know the timing for the maintenance work on the filtration cartridge 217 since the flow rate of the drinking water flowing through the piping can be perceived by the flapper-type flow rate switch 351.

In addition, the drinking water device 201 is configured so that the pump P4 is operated by being interlocked with the actuating signals of the flapper-type flow rate switch 351. With such a configuration, since it is possible to automatically operate the pump P4 depending on the flow rate of the drinking water flowing through the piping, the pump P4 will not be operated when the hollow fiber membrane 230 of the filtration cartridge 217 clogs. As a result, it will also lead to the prolonged life of the pump P4.

Moreover, by adopting the flapper-type flow rate switch 351, since the flow rate of the drinking water flowing through the piping can be detected merely by installing additional flapper-type flow rate switch 351, it is possible to produce the equipment without making the production process and the like complex and to know the flow rate reliably.

In addition, the indicating unit 353 that indicates the operating state of the flapper-type flow rate switch 351 is provided on the wall surface 352 of the casing 202. With such a configuration, it is possible to know the timing for the maintenance work on the filtration cartridge 217 reliably since the flow rate of the drinking water flowing through the piping can be perceived by the lighting state of the lamp 354 of the indicating unit 353.

Moreover, since it is possible to indicate when the maintenance work on the filtration cartridge 217 is needed at a position visible from a user by the lighting state of the lamp 354 of the indicating unit 353 indicating the timing for the maintenance work on the filtration cartridge 217, it is possible to perform maintenance work on the filtration cartridge 217 at appropriate timing.

Note that the fifth embodiment is not limited to the above description and, for example, the following aspect may be employed.

Although it is configured that the actuating signals of the flapper-type flow rate switch are indicated in the indicating unit in the present embodiment, the operating state of the pump may be indicated.

Although the filtration cartridge is removed by rotating the water outlet in the present embodiment, it is also possible to remove the filtration cartridge after removing the water storage section from the upper part of the casing or to adopt other methods.

Although the indicating unit is disposed in the front surface of the casing in the present embodiment, the unit may be disposed in any positions of the casing. However, it is preferable that the unit and the lever be present on the same surface since the flash of the lamp is readily visible.

### INDUSTRIAL APPLICABILITY

According to the drinking water device of the present invention, the drinking water flowing out from the water outlet can be kept clean since microbes are removed due to the provision of the filtering device. In addition, it is possible to remove extremely tiny microbes when the filtering device is formed from a hollow fiber membrane, whereas the filtering device formed from an adsorbent is capable of removing malodor, and thus the drinking water can be kept cleaner. Moreover, by providing the reserve passage, it is possible to keep the entire path of drinking water in a clean condition without overloading the filtering device. Due to the filtering device and the reserve passage of the present invention, it is possible to reduce the frequency of the maintenance work such as cleaning and to suppress the running cost.

In addition, according to the drinking water device of the present invention, the replacement operation or the maintenance work of the filtering device will become easy by making the filtering device attachable/detachable.

Moreover, according to the drinking water device of the present invention, the maintenance work on the filters can be carried out at an appropriate timing since the flow rate of the water flowing through the piping is detected, controlled, and indicated.

1. A drinking water device comprising:
an installation type casing;
a water storage section storing drinking water inside the casing;
a water outlet provided outside the casing and flushes drinking water from the water storage section;
a passage connecting the water storage section and the water outlet; and
a filtering device provided in the passage on further upstream side of the water outlet.

2. The drinking water device according to claim 1, further comprising a flow rate switch provided between the water storage section and the water outlet and detects a flow rate of the drinking water and also outputs an actuating signal when a flow rate within a preset flow-rate range is detected.

3. The drinking water device according to claim 1, further comprising a return pipe with respect to the passage connecting the filtering device and the water storage section, wherein one end of the return pipe is linked to the passage while the other end thereof is open to air.

4. The drinking water device according to claim 3, wherein an angle α formed between the passage and the return pipe in a connecting portion is 90 to 180°.

5. The drinking water device according to claim 1, further comprising pumping device provided between the water storage section and the water outlet and pumps the drinking water.

6. The drinking water device according to claim 5, wherein the pumping device is controlled to be driven or to be stopped by an output signal outputted from the flow rate switch.

7. The drinking water device according to claim 1, further comprising a heating device provided in the passage on a downstream side of the filtering device.

8. The drinking water device according to claim 1, further comprising a filtering device which filters the drinking water and provided between the water storage section and the water outlet so as to be freely attachable/detachable.

9. The drinking water device according to claim 1, wherein the casing includes an opening where the filtering device is insertable, and the water outlet is provided in the opening so as to be freely attachable/detachable.

10. The drinking water device according to claim 1, wherein the filtering device and the water outlet are formed integrally, and the filtering device is provided so as to be freely attachable/detachable with respect to the water outlet.

11. The drinking water device according to claim 1, wherein the filtering device is provided so as to be freely attachable/detachable with respect to the water storage section.

12. The drinking water device according to claim 1, further comprising cooling device in the water storage section which cools drinking water stored in the water storage section.

13. The drinking water device according to claim 1, further comprising a water path of the drinking water which is constituted by the filtering device and provided so as to be substitutable with a reserve passage.

14. The drinking water device according to claim 2, wherein the flow rate switch is a flapper-type flow rate switch.

15. The drinking water device according to claim 2, further comprising an indicating unit on a surface of the casing which indicates an output state of an actuating signal by lighting of a lamp.

16. The drinking water device according to claim 15, wherein the indicating unit is interlocked with a lever, which is disposed on the water outlet and controls a flow of drinking water from the water outlet, and indicates clogging of the filtering device when a flow rate lower than a lower limit value of a preset flow rate range is detected by the flow rate switch.

17. The drinking water device according to claim 1, wherein the filtering device is a filter medium or a filtration filter having a hollow fiber membrane and/or an adsorbent.
